(19) United States
(12) Patent Application Publication
(10) Pub. No.: US 2014/0351166 A1
(43) Pub. Date: Nov. 27, 2014

(54) Streamlined portfolio allocation method, apparatus, and computer-readable medium

(71) Applicant: David SCHLOSSBERG, East Dundee, IL (US)

(72) Inventor: David SCHLOSSBERG, East Dundee, IL (US)

(73) Assignee: Assured Concepts Group Ltd., East Dundee, IL (US)

(21) Appl. No.: 13/902,476

(22) Filed: May 24, 2013

(51) Int. Cl. G06Q 40/06

(52) U.S. Cl. CPC G06Q 40/06
USPC 705/36 R

(57) ABSTRACT

A method of allocating investment assets within a portfolio, performed by a processing device, the method including: receiving a current age value of a user; receiving a retirement age value of the user; displaying a plurality of questions for the user; receiving answers to the questions; determining a risk tolerance level for the user based on the answers to the questions; determining portfolio allocation constraints of the investment assets based on the current age, the retirement age, and the risk tolerance; determining an efficient frontier based on the constraints; determining a plurality of mixes of investment assets along the efficient frontier; displaying the efficient frontier and the plurality of mixes of investment assets; selecting at least one mix of investment assets along the efficient frontier; and displaying at least one risk statistic and at least one expected future return parameter for the selected mix of investment assets.

### BACKGROUND OF THE INVENTION

1. Field of the Invention

The invention is directed towards a streamlined and simplified portfolio allocation method, apparatus, and a non-transitory computer-readable storage medium storing software that allows a novice user, i.e. a non-financial expert, to evaluate a portfolio of investments from a return and risk perspective.

2. Description of the Related Art

There has been a large gap between investment portfolio management tools available to professional investors and those available to novice users. Portfolio optimization is not widely available to individual investors due to the high price of the software and the complexity associated with using this software. It is generally considered to be too complex to be understood by lay people, and impractical, in that the services of an expert are required to set up and interpret the model.

### SUMMARY OF THE INVENTION

Therefore, there is a need for a computer-based system which implements a method in which a novice user can build a portfolio and evaluate the portfolio from a return and risk perspective in a straightforward manner. While existing software designed for professional investors can assist a client in determining historical “rear looking” returns of a grouping of individual investments (such as QuickBooks or even Yahoo Finance), software does not presently exist in which a novice user can easily evaluate the risk characteristics (such as standard deviation, R², Information Ratio, Up/Down Capture, etc.) of a grouping of investments.

A non-limiting embodiment of the invention is directed to a method of allocating investment assets within a portfolio. The method is performed by a processing device, and the method includes: receiving a current age value of a user, and storing the current age value in a memory; receiving a retirement age value of the user, and storing the retirement age value in the memory; and displaying, on a display screen, a plurality of questions for the user. The method also includes: receiving answers to the plurality of questions, and storing the answers in the memory; determining, with the processing device, a risk tolerance level for the user based on the answers to the plurality of questions; and determining, with the processing device, portfolio allocation constraints of the investment assets based on the current age value, the retirement age value, and the risk tolerance level. In addition, the method includes determining an efficient frontier based on the portfolio allocation constraints of the investment assets; determining, with the processing device, a plurality of mixes of investment assets along the efficient frontier; and displaying the efficient frontier and the plurality of mixes of investment assets on the display screen. Further, the method includes selecting at least one mix of investment assets among the plurality of mixes of investment assets along the efficient frontier; and displaying at least one risk statistic and at least one expected future return parameter for the selected at least one mix of investment assets.

A non-limiting embodiment of the invention is directed to non-transitory computer-readable storage medium storing executable instructions which when executed by a processor perform a method of allocating investment assets within a portfolio. The method includes: receiving a current age value of a user, and storing the current age value in a memory; receiving a retirement age value of the user, and storing the retirement age value in the memory; and displaying, on a display screen, a plurality of questions for the user. The method also includes: receiving answers to the plurality of questions, and storing the answers in the memory; determining, with the processing device, a risk tolerance level for the user based on the answers to the plurality of questions; and determining, with the processing device, portfolio allocation constraints of the investment assets based on the current age value, the retirement age value, and the risk tolerance level. In addition, the method includes determining an efficient frontier based on the portfolio allocation constraints of the investment assets; determining, with the processing device, a plurality of mixes of investment assets along the efficient frontier; and displaying the efficient frontier and the plurality of mixes of investment assets on the display screen. Further, the method includes selecting at least one mix of investment assets among the plurality of mixes of investment assets along the efficient frontier; and displaying at least one risk statistic and at least one expected future return parameter for the selected at least one mix of investment assets.

A non-limiting embodiment of the invention is directed to a method of allocating investment assets within a portfolio, the method is performed by a processing device. The method includes: receiving a current age value of a user, and storing the current age value in a memory; receiving a retirement age value of the user, and storing the retirement age value in the memory; selecting a starting portfolio, that is a mix of investment assets, from a plurality of portfolios; and selecting an ending portfolio, that is a mix of investment assets, from the plurality of portfolios. The method also includes selecting a glide path profile from among a plurality of glide path profiles; selecting an amount of time between reallocation of the investment assets; determining, with a processing device, asset allocations of the investment assets at various times along the selected glide path profile based on the current age value of the user, the retirement age value of the user, the starting portfolio, the ending portfolio, the selected glide path, and the amount of time between reallocation; and displaying the asset allocations of the investment of assets at the various times.

A non-limiting embodiment of the invention is directed to a non-transitory computer-readable storage medium storing executable instructions which when executed by a processor perform a method of allocating investment assets within a portfolio. The method includes: receiving a current age value of a user, and storing the current age value in a memory; receiving a retirement age value of the user, and storing the retirement age value in the memory; selecting a starting portfolio, that is a mix of investment assets, from a plurality of portfolios; and selecting an ending portfolio, that is a mix of investment assets, from the plurality of portfolios. The method also includes selecting a glide path profile from among a plurality of glide path profiles; selecting an amount of time between reallocation of the investment assets; determining, with a processing device, asset allocations of the investment assets at various times along the selected glide path profile based on the current age value of the user, the retirement age value of the user, the starting portfolio, the ending portfolio, the selected glide path, and the amount of time between reallocation; and displaying the asset allocations of the investment of assets at the various times.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a page of a graphical user interface according to an embodiment of the present invention.

FIG. 2 shows a page of a graphical user interface according to an embodiment of the present invention.

FIG. 3 shows a page of a graphical user interface according to an embodiment of the present invention.

FIG. 4 shows a page of a graphical user interface according to an embodiment of the present invention.

FIG. 5 shows a page of a graphical user interface according to an embodiment of the present invention.

FIG. 6 shows a page of a graphical user interface according to an embodiment of the present invention.

FIG. 7 shows a page of a graphical user interface according to an embodiment of the present invention.

FIG. 8 shows a page of a graphical user interface according to an embodiment of the present invention.

FIG. 9 shows a page of a graphical user interface according to an embodiment of the present invention.

FIG. 10 shows a page of a graphical user interface according to an embodiment of the present invention.

FIGS. 11A-C show a page of a graphical user interface according to an embodiment of the present invention.

FIG. 12 shows a page of a graphical user interface according to an embodiment of the present invention.

FIG. 13 shows a page of a graphical user interface according to an embodiment of the present invention.

FIGS. 14A-B show a page of a graphical user interface according to an embodiment of the present invention.

FIG. 15 shows a page of a graphical user interface according to an embodiment of the present invention.

FIGS. 16A-B shows a page of a graphical user interface according to an embodiment of the present invention.

FIGS. 17A-B show a page of a graphical user interface according to an embodiment of the present invention.

FIG. 18 shows a page of a graphical user interface according to an embodiment of the present invention.

FIGS. 19A-B show a page of a graphical user interface according to an embodiment of the present invention.

FIGS. 20A-B shows a page of a graphical user interface according to an embodiment of the present invention.

FIGS. 21A-B shows a page of a graphical user interface according to an embodiment of the present invention.

FIG. 22 shows a page of a graphical user interface according to an embodiment of the present invention.

FIGS. 23A-B show a page of a graphical user interface according to an embodiment of the present invention.

FIG. 24 is a circuit diagram associated with an embodiment of the present invention.

FIG. 25 is a flow chart demonstrating a method performed in an embodiment of the present invention.

FIG. 26 is a flow chart demonstrating a method performed in an embodiment of the present invention.

FIG. 27 is a flow chart demonstrating a method performed in an embodiment of the present invention.

### DETAILED DESCRIPTION OF THE PREFERRED EMBODIMENTS

Referring now to the drawings, wherein like reference numerals designate identical or corresponding parts throughout the several views.

The invention is directed towards a streamlined and simplified portfolio allocation method, apparatus, and non-transitory computer-readable storage medium storing software that is comprised of four sections, or modules. The modules are called the Reporting Module, the Portfolio Builder Module, the Custom Target Date Module, and the Gap Analysis Module. What makes the invention unique is that it can be based on web-based software, run by a processor device of a computer, mobile device, etc., and designed in a very simplified fashion to allow a novice, i.e. non-financial expert, to evaluate a portfolio of investments from a return and risk perspective. In a non-limiting embodiment, the investment tool could be accessed via the internet over a web browser such as Microsoft Internet Explorer©, Google Chrome©, Mozilla Firefox©, etc. running on a computer or other device including a processor device built by AMD©, Intel©, etc. The user of the investment tool could gain access to the features by paying a subscription fee and logging into the investment tool using a user name and password.

The first section, the Reporting Module, allows a novice user to evaluate the return and risk characteristics of a group of investments rather than attempting to evaluate individual investment return and risk characteristics. Thus, an important feature of the invention is that it is a group of investments, and not an individual investment, that is being evaluated by the system in terms of return and risk parameters.

Also, in an embodiment of the invention, the risk associated with other benchmarks such as the S&P 500 and/or other allocation type approaches such as target date funds (2020 fund, 2025 fund, etc.) are displayed so that the user can compare the risks and returns associated with several portfolios that are generated by the system to the benchmarks. A variety of template reports as well as online printed and video education is made available to assist the user in evaluating the use of the system, the features and benefits, as well as the outputted results.

While the first section, the Reporting Module, allows the user to evaluate risk based on investment allocations they may manually enter, the second section, the Portfolio Builder Module, asks a user a series of questions, and based on the answers to the questions, the user's risk tolerance is evaluated. Based on the user's determined risk level, allocation constraints will be determined and an efficient frontier that can be established using the available individual investments will be displayed, allowing the user to select several different portfolios along the efficient frontier. An efficient frontier is a set of optimal portfolios that offer the highest expected return for a defined level of risk or the lowest risk for a given level of expected return. Portfolios that lie below the efficient frontier are sub-optimal, because they do not provide enough return for the level of risk. Portfolios that cluster to the right of the efficient frontier are also sub-optimal, because they have a higher level of risk for the defined rate of return.

In addition to the allocation recommendations, forward thinking “likely” result ranges of returns and risk statistics (i.e. predicted further return and risk statistics) are provided to the user based on the historical variances of those investments. Several parameters associated with risk of the portfolio, e.g. standard deviation, and several parameters associated with the historical and likely future returns of the portfolios are displayed for each portfolio. Also, the risk associated with other benchmarks such as the S&P 500 and/or other allocation type approaches such as target date funds (2020 fund, 2025 fund, etc.) are displayed so that the user can compare the risks and returns associated with the several generated portfolios to the benchmarks. The third section, the Custom Target Date Module, creates a customized target date fund for the user, allowing for revisions to allocations based on a current investment allocation and a future investment allocation using either an allocation from the Reporting Module or a created allocation in the Portfolio Builder Module.

The fourth section, the Gap Analysis Module, will assist the user in determining the statistical likelihood of success in reaching their financial goals, as well as how much more they might want to save in order to reach their desired statistical likelihood of success. This is called gap analysis. A unique feature of the invention is that a novice has the ability to use a “Monte Carlo” simulation in this gap analysis rather than a static annual rate of return, and utilize this simulation based on very specific investment choices taking into account the return and risk characteristics of the portfolio set. A “Monte Carlo Simulation” is a problem solving technique used to approximate the probability of certain outcomes by running multiple trial runs, called simulations, using random variables. Additionally unique, the invention also has the ability to change from one portfolio to multiple portfolios sets and have this compounded result utilized to provide the gap analysis. The gap analysis uses current savings, anticipated future savings, and anticipated future withdrawals in addition to the return/risk characteristics to determine the statistical likelihood of reaching the desired result.

As described above, the invention consists of four distinct modules (Reporting Module, Portfolio Builder Module, Custom Target Date Module, and Gap Analysis Module) each with separate functions, but that interact with each other.

The primary purpose of the Reporting Module is to provide education and reporting information on the return and risk history data on a variety of user created allocation portfolios. This reporting information can be used by a layperson along with the provided education in order to determine the historical effectiveness of differing portfolio allocations when it comes to both historical return data as well as an abundance of relevant historical risk statistics. These risk statistics may include but are not limited to: Standard Deviation, Beta, Sharpe Ratio, Information Ratio, Up-Down Capture, K-Ratio, R², etc. The above risk statistics will be described in detail below.

Standard deviation of return measures the average deviations of a return series from its mean, and is often used as a measure of risk. A large standard deviation implies that there have been large swings in the return series of the manager. Standard deviation can be calculated in two ways:

1. Standard Deviation assumes that the returns series is a sample of the population.
This is the calculation most commonly used. The standard deviation of the return series is the square root of the variance:

$$StdDev ( {r}_{1} , … , {r}_{n} ) = \sqrt{\frac{1}{n - 1} {\sum }_{i = 1}^{n} {( {r}_{i} - \overline{r} )}^{2}}$$

where r₁, . . . , rₙ is a return series, i.e., a sequence of returns for n time periods.

2. Population Standard Deviation assumes that the return series is the population.

Population Standard Deviation is the square root of the population variance:

$$PStdDev ( {r}_{1} , … , {r}_{n} ) = \sqrt{\frac{1}{n} {\sum }_{i = 1}^{n} {( {r}_{i} - \overline{r} )}^{2}}$$

Standard Deviation and Population Standard Deviation are the square root of Variance and Population Variance.

Turning now to Beta, the Alpha and Beta of a manager versus a benchmark are obtained by fitting a straight line to the points in a scatter plot of the market returns vs. the manager's returns. Alpha is the intercept of this straight line, while Beta is the slope. Hence, if the market returns change by some amount x, then the manager returns can be expected to change by Beta*x.

Beta is defined as:

$$\frac{( covariance of manager and benchmark )}{( variance of benchmark )}$$

More explicitly, this is:

$$\frac{{\sum }_{i = 1}^{n} ( {m}_{i} - \overline{m} ) * ( {b}_{i} - \overline{b} )}{{\sum }_{i = 1}^{n} {( {b}_{i} - \overline{b} )}^{2}}$$

where:
n=number of returns
mi=i-th manager return
m̅=average manager return
bi=i-th benchmark return
b̅=average benchmark return
   Beta is a measure of systematic risk, or the sensitivity of a manager to movements in the benchmark. A Beta of 1 implies that you can expect the movement of a manager's return series to match that of the benchmark used to measure Beta.

Turning now to Sharpe Ratio, the Sharpe Ratio of a manager series is the quotient of the annualized excess return of the manager over the cash equivalent and the annualized standard deviation of the manager return.

Sharpe Ratio=(AnnRtn(r₁, . . . , rₙ)−AnnRtn(c₁, . . . , cₙ))/AnnStdDev(r₁, . . . , rₙ)

where:
r₁, . . . , rₙ=manager return series
c₁, . . . , cₙ=cash equivalent return series
   The Sharpe Ratio is a risk-adjusted measure of return which uses standard deviation to represent risk.

Next, the Information Ratio of a manager series vs. a benchmark series is the quotient of the annualized excess return and the annualized standard deviation of excess return.

Information Ratio=(AnnRtn(r₁, . . . , rₙ)−AnnRtn(s₁, . . . , sₙ))/AnnStdDev(e₁, . . . , eₙ)

where:
r₁, . . . , rₙ=manager return series
s₁, . . . , sₙ=benchmark return series
e₁, . . . , eₙ=r₁−s₁, . . . , rₙ−sₙ
   The Information Ratio measures the consistency with which a manager beats a benchmark.

Up-Down Capture is a measure of how well a manager was able to replicate or improve on phases of positive benchmark returns, and how badly the manager was affected by phases of negative benchmark returns. To calculate the up capture, we first form new series from the manager and benchmark series by dropping all time periods where the benchmark return is zero or negative. The up capture is then the quotient of the annualized return of the resulting manager series, divided by the annualized return of the resulting benchmark series. The down capture is calculated analogously.

$$UpCapture = \frac{{( {\sum }_{i = 1}^{{n}_{p}} 1 + {r}_{i} )}^{\frac{1}{y}} - 1}{{( {\sum }_{k = 1}^{{n}_{p}} 1 + {s}_{k} )}^{1 / y} - 1}$$

where
nₚ=number of positive benchmark returns
sₖ=k-th positive benchmark return
rᵢ=manager return for the same period as the i-th positive benchmark return
y=number of years, counting periods of positive benchmark returns only.
   For the down capture, the non-positive returns are used instead of the positive ones.

K-Ratio is a ratio that is used in the performance evaluation of an equity relative to its risk. The ratio examines the consistency of an equity's return over time. The data for the ratio is derived from a value added monthly index (VAMI), which tracks the progress of a $1,000 initial investment in the security being analyzed.
The K-Ratio is calculated as:

$$K \text{-} Ratio = \frac{Slope of LOGVAMI Regression Line}{\begin{matrix}( StandardError of the Slope ) * \\ ( Number of Periods in the LogVAMI )\end{matrix}}$$

R² is a statistical measure that represents the percentage of a fund or security's movements that can be explained by movements in a benchmark index. For fixed-income securities, the benchmark is the T-bill. For equities, the benchmark is the S&P 500.

The Portfolio Builder Module creates an efficient frontier and therefore the most efficient allocation portfolios from a set of underlying assets. Since the Portfolio Builder Module is linked to the Reporting Module, the asset list can be imported from the Reporting Module to reduce user entry. Additionally, the resulting allocation recommendations from the Portfolio Builder Module can be brought back into the Reporting Module.

The Custom Target Date Module creates a customized target date fund for the user, allowing for revisions to allocations based on a current investment allocation and a future investment allocation using either allocations from the Reporting Module or created allocation in the Portfolio Builder Module.

The Gap Analysis Module is intended to assist the user in determining whether the current amount saved and additional intended savings will be statistically likely to reach the user's inputted goals, given the application of an anticipated return and risk statistics as implied by a Monte Carlo simulation analysis. The Monte Carlo analysis is done using two metrics: implied rate of return, and implied standard deviation, although it is envisioned that other methods may apply additional data into the mathematical formula. Furthermore, the system may use two sets of data, one set up to a predetermined date, and another set after the predetermined date. The purpose of this function is to apply a riskier portfolio pre-retirement and a more conservative portfolio after retirement. Furthermore, in other embodiments, the system may include an annually adjusting glide path between the pre-retirement portfolio and the post-retirement portfolio.

### The Reporting Module

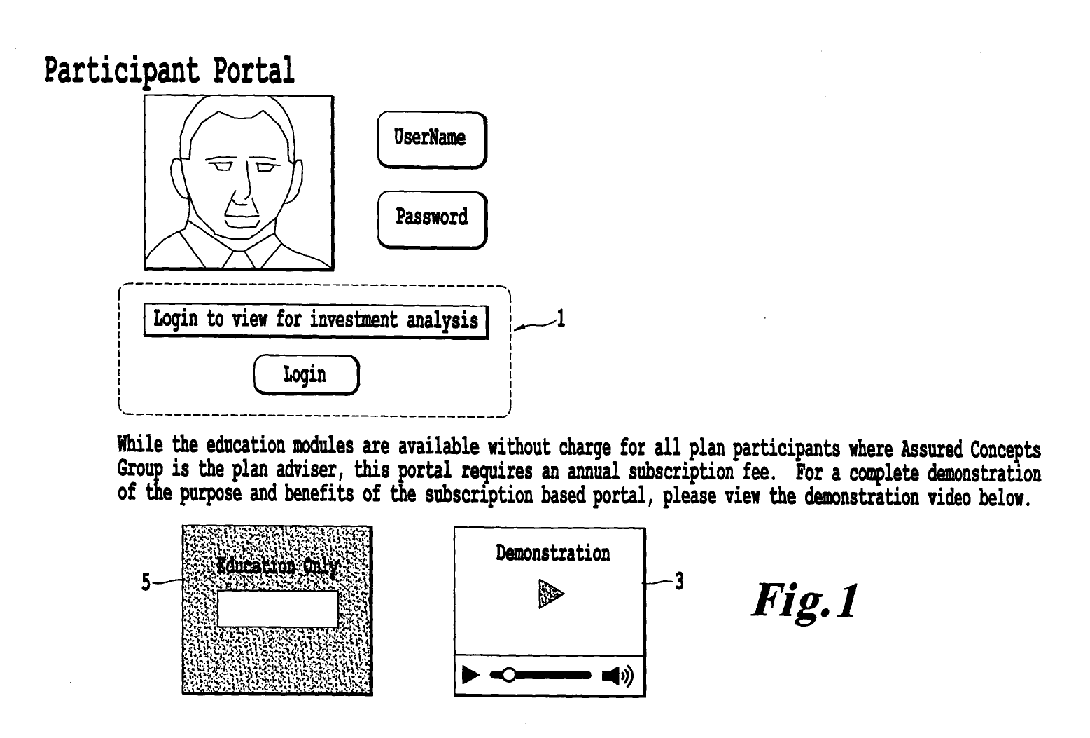

Features of the Reporting Module will now be discussed. FIG. 1 shows a main portal page that consists of, for example, login area 1, a demonstration video link 3, and an educational module link 5 that provides access to educational modules which could contain educational documents in several formats (e.g. PDF, Word) and/or video files. It is possible that there could be a security feature in which only users who pay and subscribe to a service can gain access to the program through the portal page.

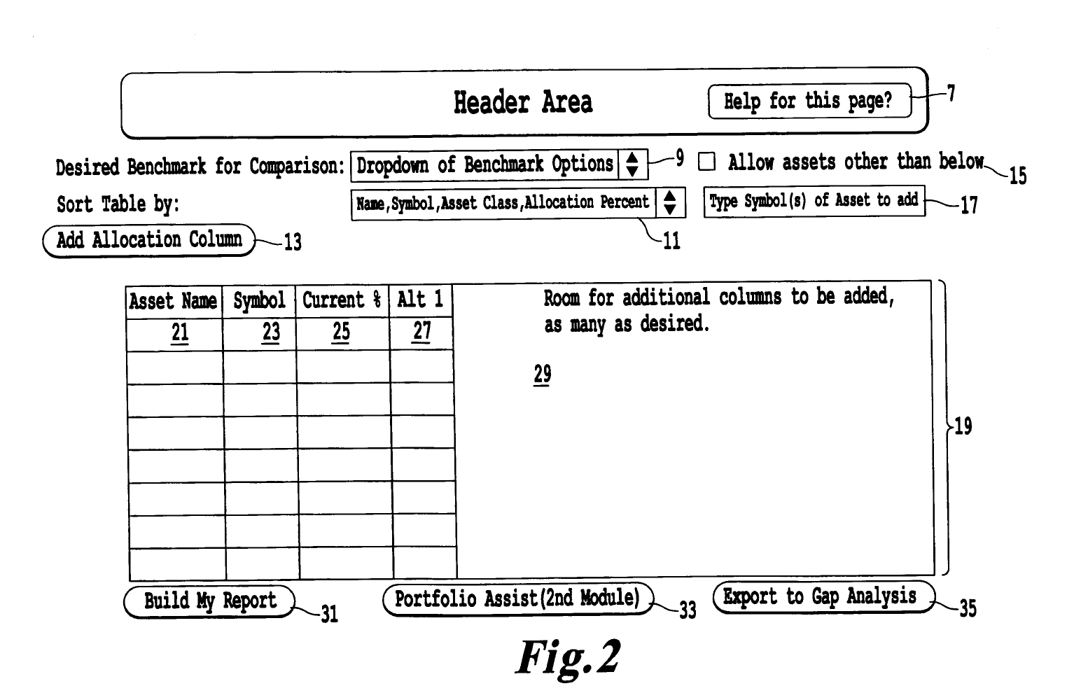

FIG. 2 shows the first page a user will see after logging in through the main portal page of FIG. 1. All of the pages that are displayed are graphical user interfaces that can accept user inputs. Also, as seen in the various figures, each page includes a help button 7 for the particular page. While not shown in FIG. 2, all portal pages may also have some navigation keys including a home button.

In FIG. 2, the user would enter the desired benchmark for report comparisons by way of, for example, a benchmark dropdown menu 9. It is also possible that the user could select the desired benchmark for report comparisons by typing in the name of the benchmark. Benchmarks available in the dropdown menu 9 could include, for example, the S&P 500, Dow Jones Industrials, Barclays Aggregate Bond, but also Target Date Indexes such as 2020, 2025, etc.

The sort table drop down menu 11 is used to identify how the spreadsheet/table displayed below the sort table drop down menu 11 would be sorted, and options include, for example, by investment name, by ticker symbol, by allocation % current column, Alt 1, Alt 2, etc. The current % column is for the user to input the current allocation percentages. Also, the Alt 1 column, Alt 2 column, etc. reflect alternative portfolio allocations. Then the report would do comparisons between the current portfolio allocation and the alternative portfolio allocations.

Also shown in FIG. 2 is an add allocation column button 13. This button 13 adds a column to the spreadsheet below for an additional allocation to be input, so where Alt 1 is shown, Alt 2 would be added, Alt 3, etc. Each column would represent a portfolio set in the reports.

Since it is envisioned that the financial planning method is suited for 401(k) plans, it is also possible to link existing assets available in the existing 401(k) plan so that those assets would pre-populate in the spreadsheet. For example, if there are around 30 investment choices available to the client in their 401(k) plan, the 30 or so investment choices will pre-populate when the user logs in so the 30 current choices would pre-fill and save the user entry time. The asset checkbox 15 and an asset input box 17 allow for the addition of assets to the list thereby expanding the rows in the table. While asset input box 17 indicates to input a symbol, it is also possible that asset input box 17 could allow other input methods such as by name, text or keyword searches, etc. Since the invention can be used by the investing public in general and is not limited to only 401(k) participants, asset input box 17 allows for the entry of any and all assets in the mutual fund and ETF world. Stocks could be specifically excluded from entry into asset input box 17. It is also possible that additional asset types such as stocks could be allowed to be entered into asset input box 17.

FIG. 2 also shows a table 19. The first column in the table 19 is an asset name column 21 that contains the name of each investment. The second column in table 19 is a symbol identification column 23 which identifies the corresponding investment symbol for the particular investment. The third column in the table 19 is a current percentage column 25 which allows the user to input current allocation percentages. The current percentage column 25 as well as Alt 1 column 27, Alt 2 column etc. must all add up to 100% to proceed. In a non-limiting embodiment, a sum total on the bottom row is displayed, and entries in the column appear in red until they add up to 100%, then the entries change color to blue or black. Also, if a user attempts to proceed when the entries do not add up to 100%, a warning box would appear that identifies the column that fails to meet the test.

FIG. 2 also shows a fourth column, the Alt 1 column 27. Additional columns may be created in the table 19 by selecting the add allocation column button 13. Display area 29 is an area where additional columns would appear if the user selects the add allocation column button 13.

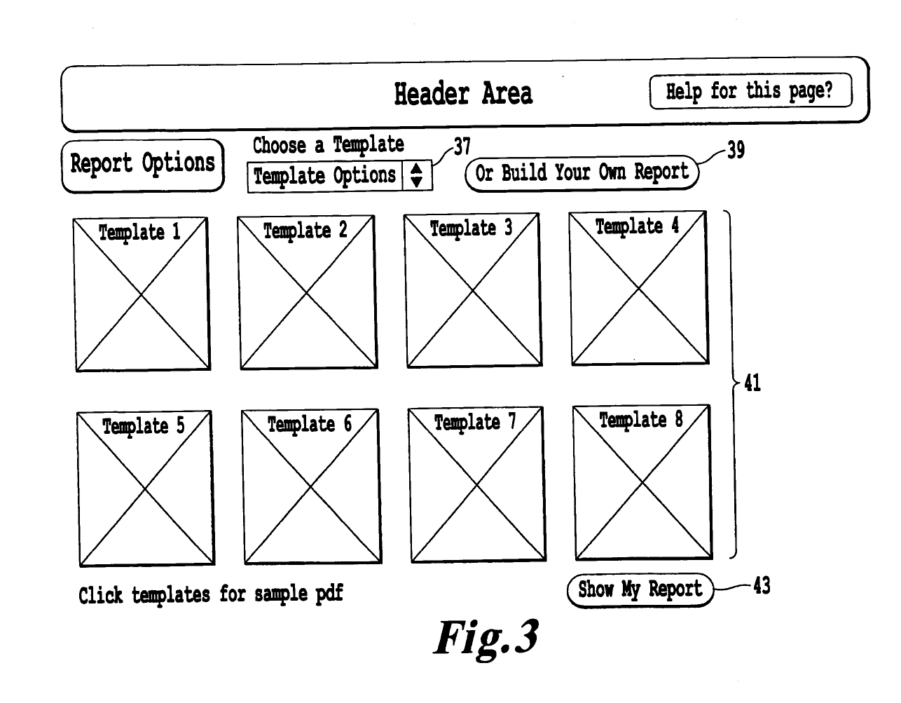

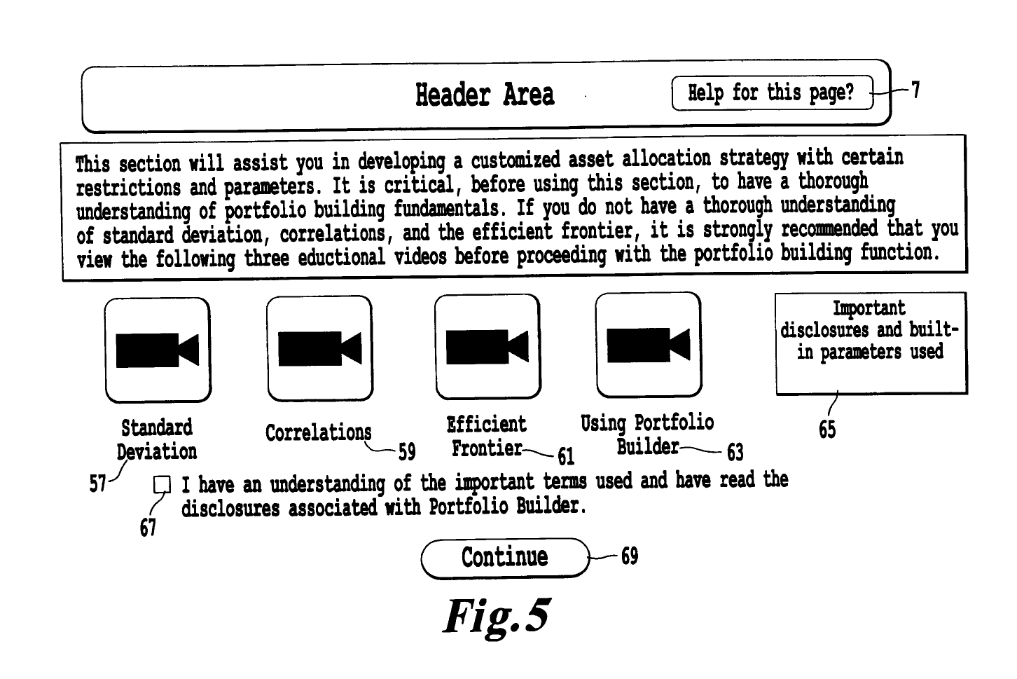

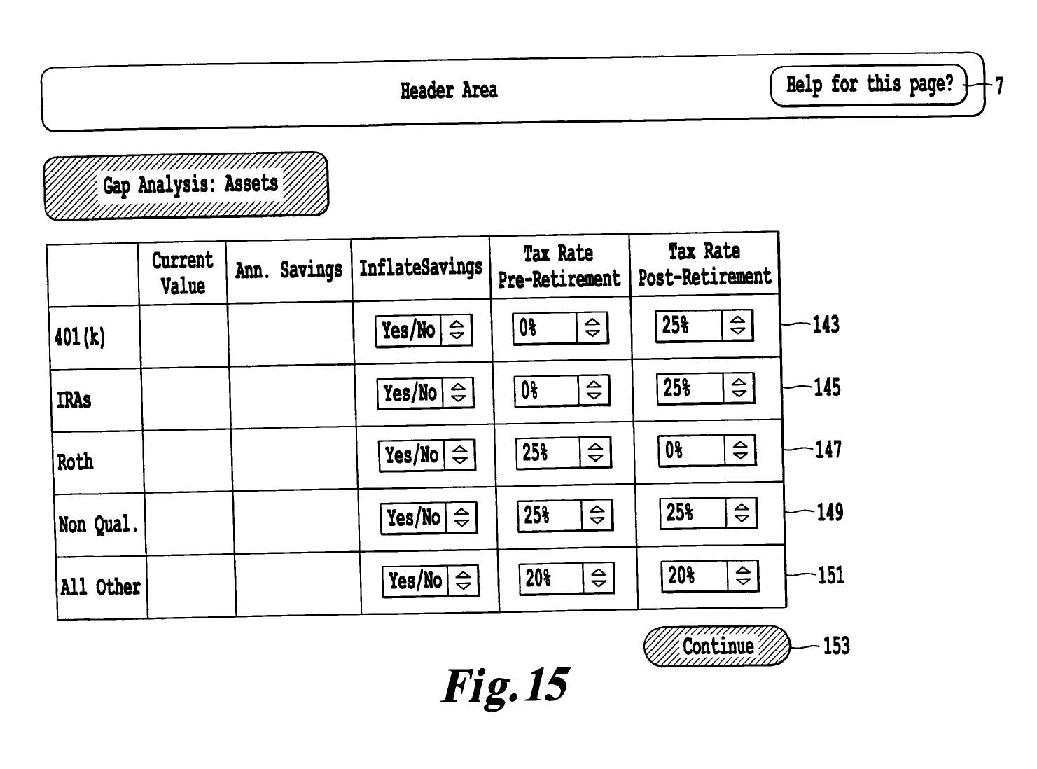

The build my report link 31 in FIG. 2 is a navigational link, which when selected, takes the user to the graphical user interface shown in FIG. 3. The portfolio assist link 33 is a navigational link which when selected, takes the user to the graphical user interface shown in FIG. 5. Also shown in FIG. 2 is an export to gap analysis link 35, which when selected, takes the user to the graphical user interface shown in FIG. 15.

FIG. 3 shows a page that displays report options of the Reporting Module. FIG. 3 includes a template options drop down menu 37. The template options drop down menu 37 allows a user to select a template from one of the entries displayed below the template options drop down menu 37. FIG. 3 also displays a build your own report button 39, which when selected by the user, takes the user to a separate screen where they can build their own report. FIG. 3 also shows multiple samples that are displayed on various templates 41. The user can select a template 41 and a PDF representation of the template enlarges for easy viewing. It is possible for the representation to be displayed in other formats other than PDF. The show my report button 43 is a button which, when selected by the user, causes the user's report to be opened as a PDF for viewing and/or printing.

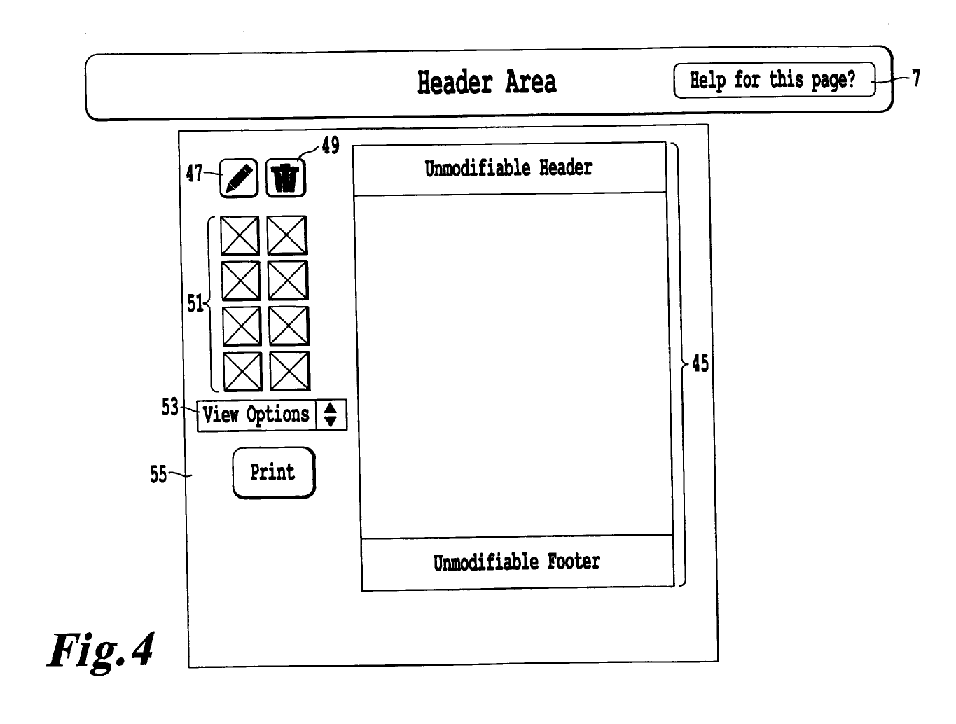

FIG. 4 shows a graphical user interface for creating custom reports in the Reporting Module. FIG. 4 includes a display area 45 that is a blank area except for an un-modifiable header and footer area. By selecting the create sections button 47, the user is able to create sections on the display area 45 with which to place various elements for their report. The create sections button 47 is a tool that will allow the user to sectionalize the page into different areas. FIG. 4 shows an erase button which when selected allows the user to erase or undo a section line. Displayed below the create sections button 47 and the erase button 49 are several icons 51 which represent various report charts or graphs that can be inserted into the various sections on the page.

FIG. 4 also includes a view options drop-down menu 53 which allows the user to elect a multi-page report with one portfolio allocation compared to a benchmark on each page, or a one-page report with all portfolio allocations together on the same page along with the benchmark. Lastly, FIG. 4 includes a print button 55 which when selected by user enables viewing of the report in PDF format, for example, which allows for easy printing of the report.

An example of how the pages of the Reporting Module are used will be described next. Prior to subscribing to the portfolio allocation service, a demonstration of the system and samples of the educational materials are available at the main login screen shown in FIG. 1. Next, the client/user logs in to the service after they have purchased a subscription to the service. The user is allowed to download a set of investment options through an excel spreadsheet. If the user is a subscribed participant, the investment options inside the 401(k) plan of enrolled 401(k) plans are pre-loaded for the user. The user selects a benchmark to compare statistical data against using the benchmark drop down menu 9 of FIG. 2. This may be the S&P 500, but target date indexes may also be utilized. Next, the user inputs assets into a spreadsheet. Next, the user can sort the table of FIG. 2 by name, symbol, or asset class by using the sort table drop down menu 11. The user can input an existing allocation if one exists simply by entering the current allocation percentages to various assets in the current % column until the total percentages add up to 100%. The user adds as many alternate allocations (Alt 1, Alt 2, etc.) as desired (by adding columns to the spreadsheet) and inputs allocations for comparison. The user clicks on link 43 when complete to view reports. A variety of report templates appear for user selection in FIG. 3 or the user can build their own report in FIG. 4. Lastly, reports are displayed to the user to view and to print.

### The Portfolio Builder Module

FIG. 5 shows a first page that is displayed in the Portfolio Builder Module. The page shown in FIG. 5 is an informative page that includes various PDFs (or other documents) and videos for educational purposes. It also includes disclosures that indicate that the system uses assumptions based on historical information which may or may not be reliable for future expectations. Much more educational information could be presented than what is represented in FIG. 5. Thus, FIG. 5 illustrates only a sampling of the educational tools. One possible educational tool is a standard deviation link 57 that allows for PDF (or another type of document) and video education on standard deviation to be accessed. The correlations link 59 allows for PDF and video education on correlations to be accessed. The efficient frontier link 61 allows for PDF and video education on an efficient frontier to be accessed. The Using Portfolio Builder link 63 allows for video education that explains how to use the Portfolio Builder Module, as well as how to examine and utilize the results that are displayed to the user.

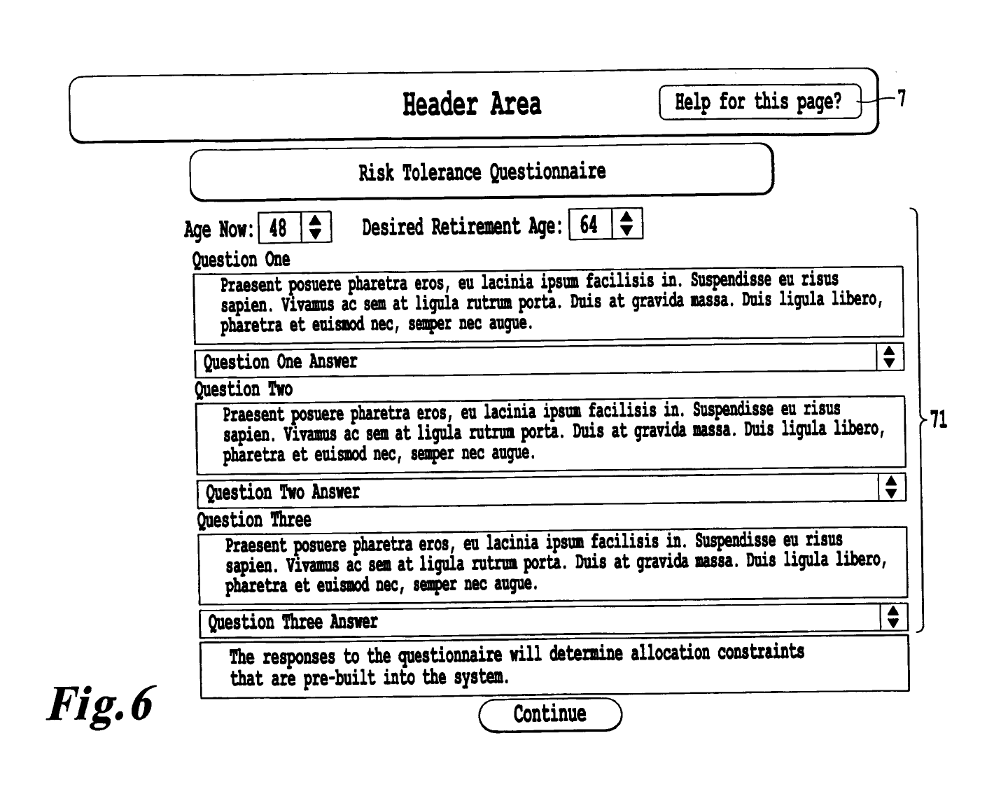

The disclosure link 65 is a link, which when selected by a user, brings up a PDF, or other document format, of disclosures and is required to be opened before continuing with the building of the portfolio. Disclosure checkbox 67 is a checkbox that has to be checked by the user before continuing the building of the portfolio. When the user selects the disclosure checkbox 67, the user indicates that they are aware of and understand the disclosure information that was previously presented to them. When the continue button 69 is selected at the bottom of FIG. 5 by the user, the next page of the Portfolio Builder Module, FIG. 6, is displayed.

FIG. 6 shows an example of a Risk Questionnaire page of the Portfolio Builder Module. This page gathers information to establish the user's investment time horizon as well as their risk tolerance. These questions are designed to understand the tolerance for risk of the investor, and then during development of the portfolio (which can be done automatically by the software), allocation constraints and ranges would be automatically determined by the system based on this information that is provided to the Risk Questionnaire. Display area 71 is an area in which various questions are displayed to the user. For example, the user inputs their current age, their desired age at retirement, and answers several risk tolerance questions. The user's responses to the Risk Questionnaire will automatically determine asset allocation constraints that are pre-built into the system.

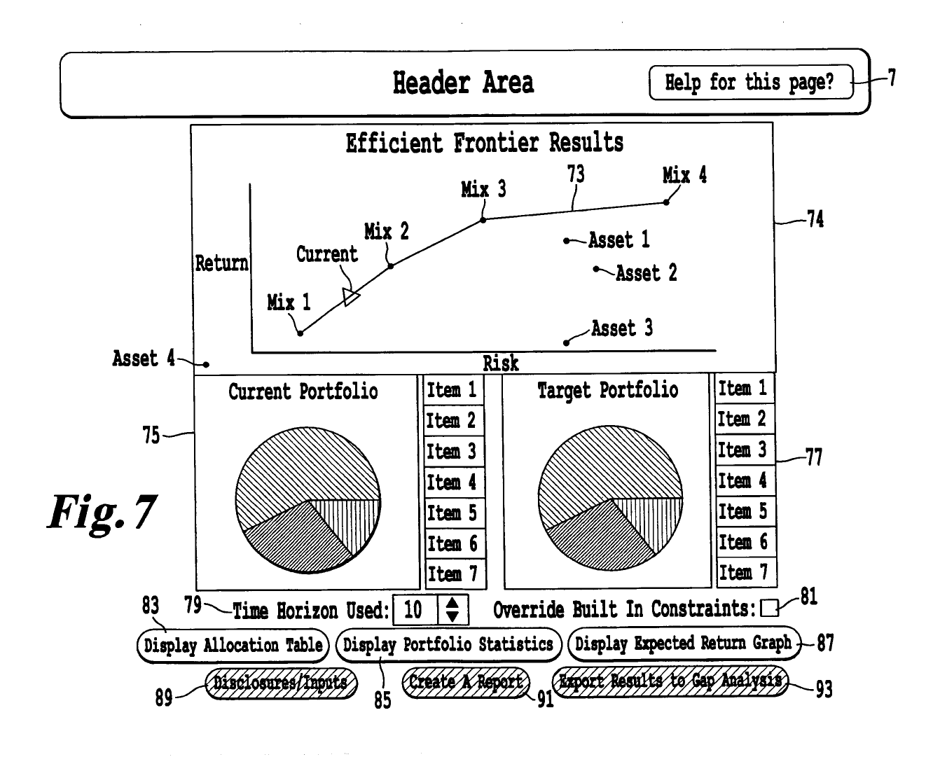

FIG. 7 displays an efficient frontier graph 74 with the resulting efficient frontier 73 that is automatically produced by the system based on the assets inputted into the system in the page shown in FIG. 2, the risk profile completed based on the information inputted into the Risk Questionnaire of FIG. 6, and the allocation constraints that were determined by the system. There will be an unlimited number of results along the efficient frontier 73. The horizontal axis of the efficient frontier graph 74 is a measurement of risk, and the amount of risk increases from left to right. The vertical axis of the efficient frontier graph 74 is a measurement of return, and the amount of return increases from the bottom to the top of the axis. As the user moves the mouse, a symbol will move up and down the efficient frontier 73 and the Target Portfolio Pie Chart 77 (or other graphic) will reflect the changing allocations as the user moves along the efficient frontier 73. The user will be prompted to hit a key to lock in various allocations which will then be reported on and considered. The system will require the user to select, for example, a minimum of three and a maximum of five allocations along the efficient frontier 73. It is possible that the user could select a different number of allocations.

In the efficient frontier graph 74 shown in FIG. 7, the user has selected four mixes along the efficient frontier: Mix 1, Mix 2, Mix 3, and Mix 4. Also shown in the efficient frontier graph 74 are four individual assets: Asset 1, Asset 2, Asset 3, and Asset 4. The individual assets are not a mix of assets, but rather a single investment. For example, an individual asset (Asset 1, Asset 2, Asset 3, and Asset 4) could be a single fund or one particular stock. One advantageous feature of the invention is demonstrated in FIG. 7. If for example the user selects Mix 3, it can be seen from the efficient frontier graph 74 that Mix 3 has a greater return than Asset 1, Asset 2, Asset 3, and Asset 4, because Mix 3 is located higher up on the graph relative to these assets, and thus has a higher return value due to it being higher up on the vertical axis. Also, Mix 3 has a lower amount of risk than Asset 1, Asset 2, and Asset 3, as Mix 3 is located to the left of Asset 1, Asset 2, Asset 3, and Asset 4 on the chart. Thus, Mix 3 is a better investment that Asset 1, Asset 2, and Asset 3 as it has a higher rate of return with a lower amount of risk than Asset 1, Asset 2, and Asset 3. Thus, this example illustrates how a novice user is able to obtain better investment results by being able to select a mix of investment assets based on return and risk parameters.

Current Portfolio Pie Chart 75 is a pie chart as well as an itemized listing of the current allocations as reflected in the Reporting Module. As mentioned above, Target Portfolio Pie Chart is a pie chart that reflects the allocations as well as a listing of the allocations in percentages as the user moves up and down the efficient frontier 73 shown in the upper figure of FIG. 7.

FIG. 7 also shows a time horizon selector 79. A time horizon is the length of time over which an investment is made or held before it is liquidated. Knowing your time horizon is extremely important when it comes to choosing the type of investments you want and your asset allocation. All things being equal, you can afford to be more aggressive with a longer time horizon. For example, most advisors would recommend that the asset allocation of a 30 year old be more heavily weighted in equities than that of someone who is close to retirement. However, age isn't the only determinant of time horizon. A 30 year old who is saving money for a down payment on a house in one year would be investing with a one-year time horizon, despite the fact that retirement is years away. Given the short time frame, it would be prudent to invest more conservatively because there is little time to make up any losses. The longer the time horizon, the more accurate the expected returns are likely to be. For example, over 20 years one might reasonably assume the S&P 500 will generate an 8% return with a 85% probability of hitting that target, while over a one year period, the range for the possible return of the S&P 500 over 1 year periods is very great, and therefore reduces the probability of hitting the target.

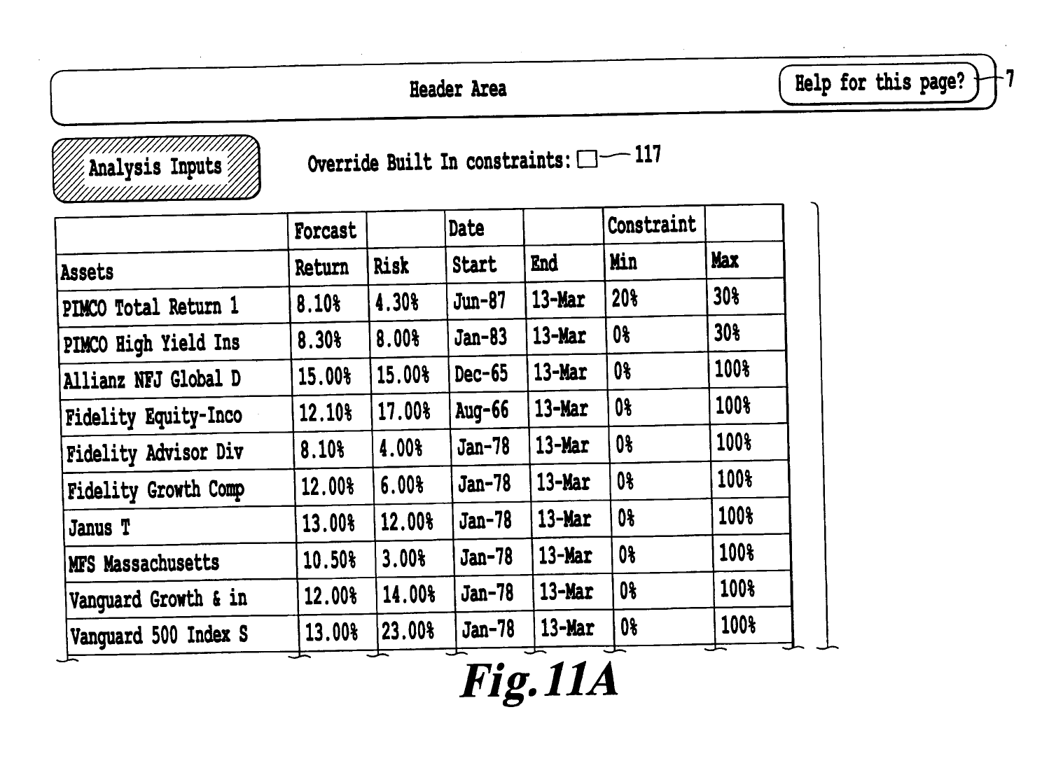

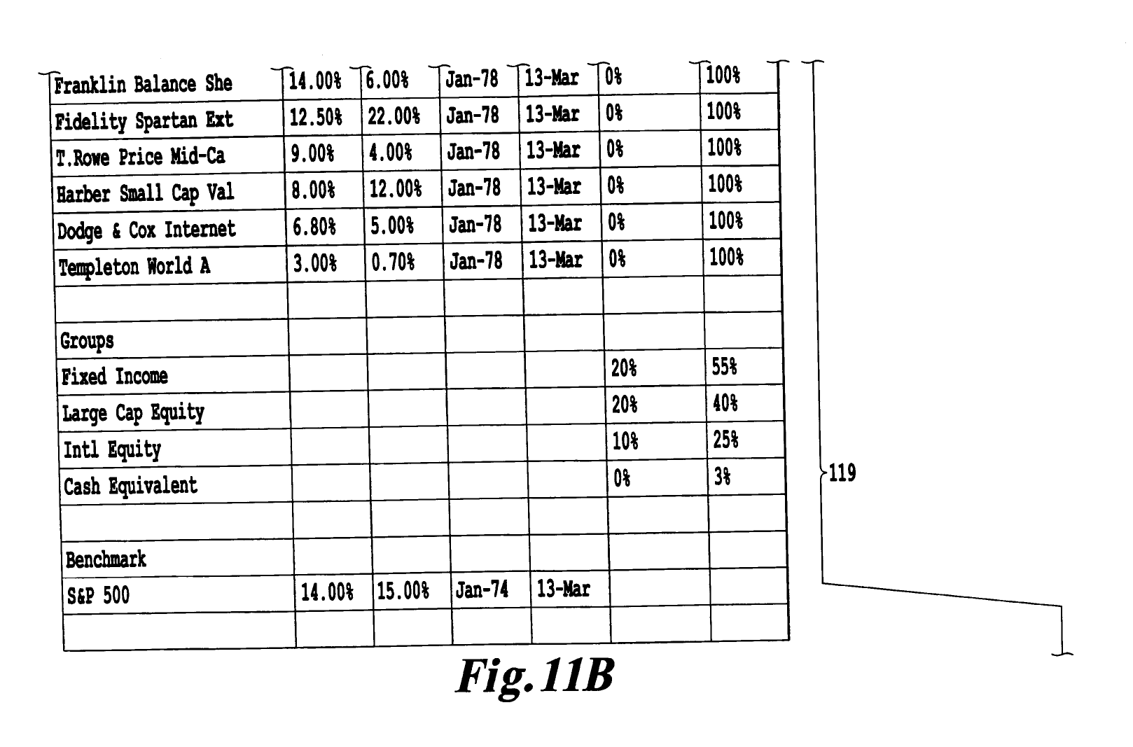

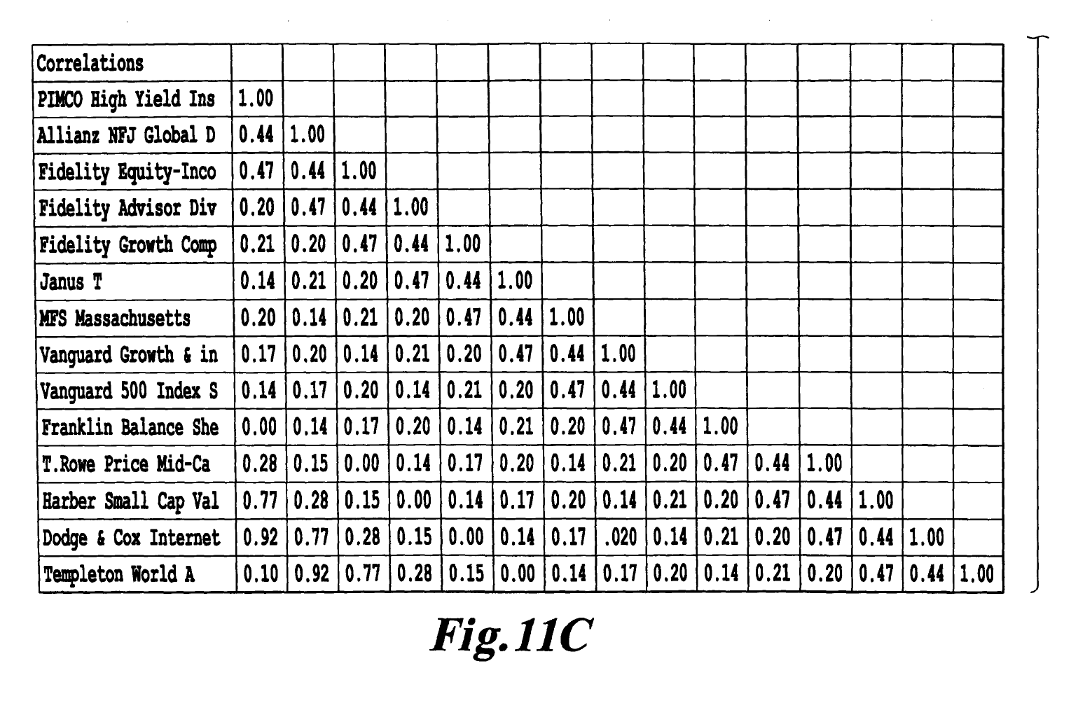

A default time horizon will be automatically selected by the system based on the amount of years to retirement inputted by the user into the screen of FIG. 6, however a drop-down of the time horizon selector 79 will allow the user to modify the time horizon if needed. In an exemplary embodiment, it is possible for the system to allow the minimum time horizon to be 10 years. Since constraints will be pre-formulated based on the user's inputs on the graphical user interface of FIG. 6, when the user checks an override box 81, the user will be brought to a page shown in FIGS. 11 A-C or a similar page where they will be allowed to override the built-in constraints of the system.

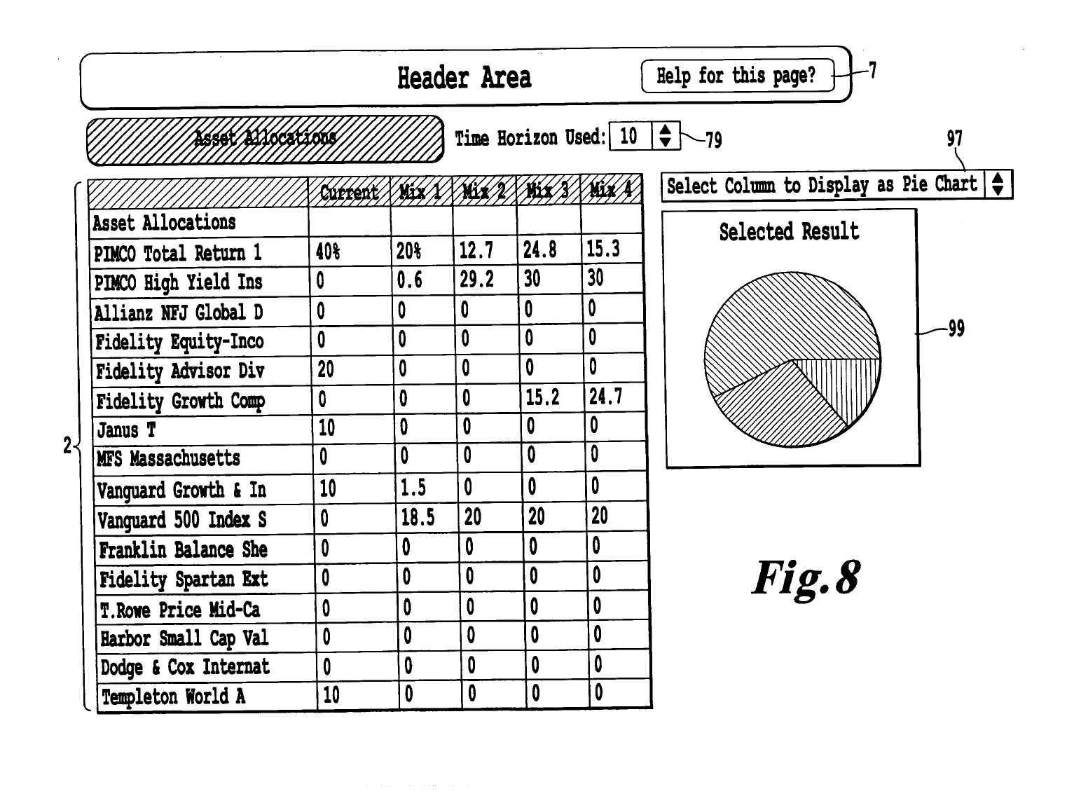

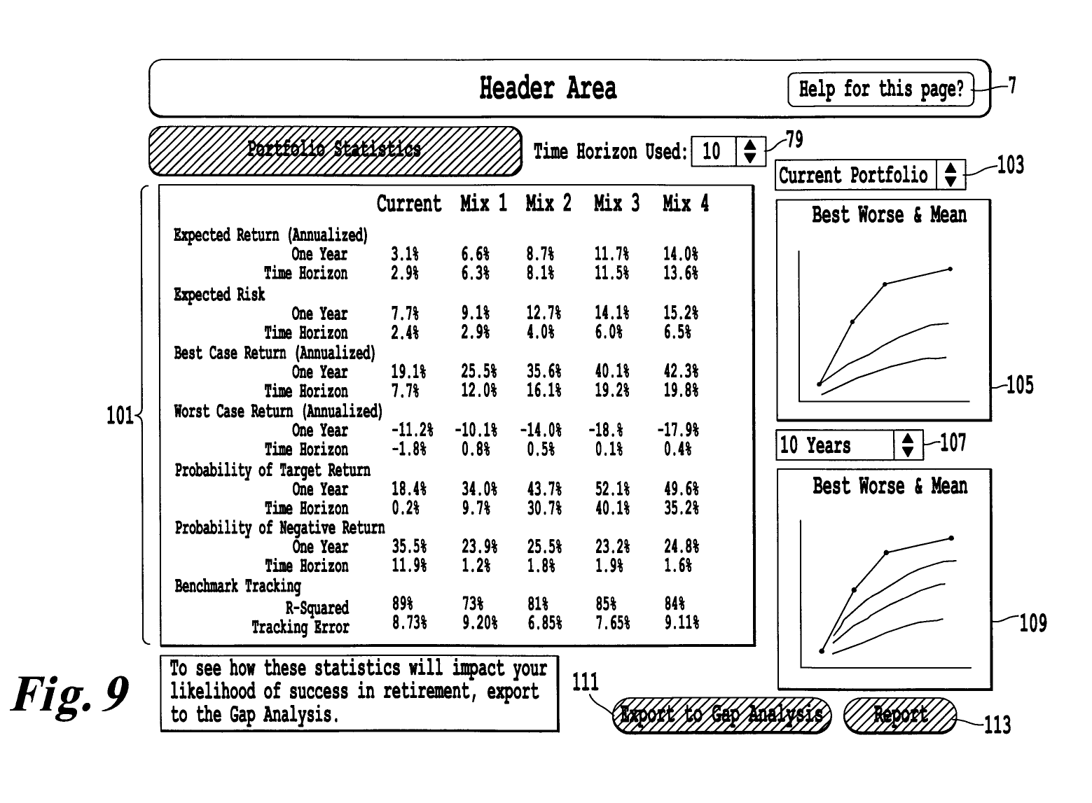

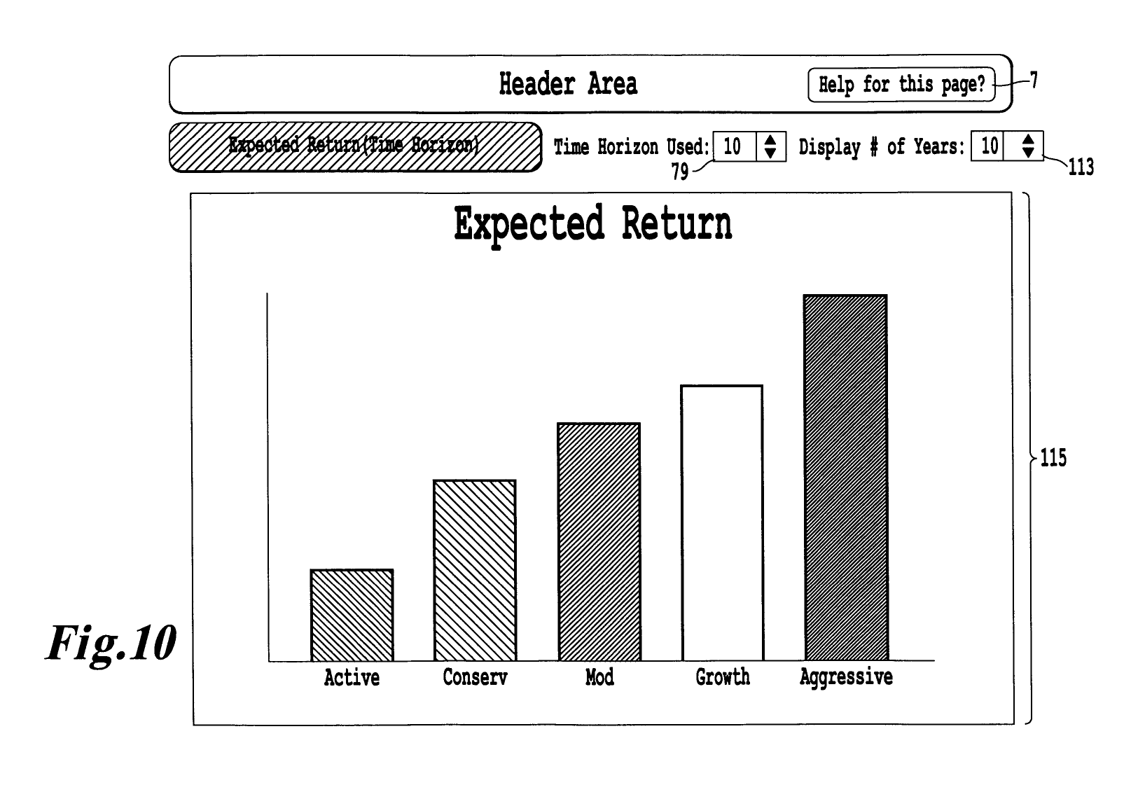

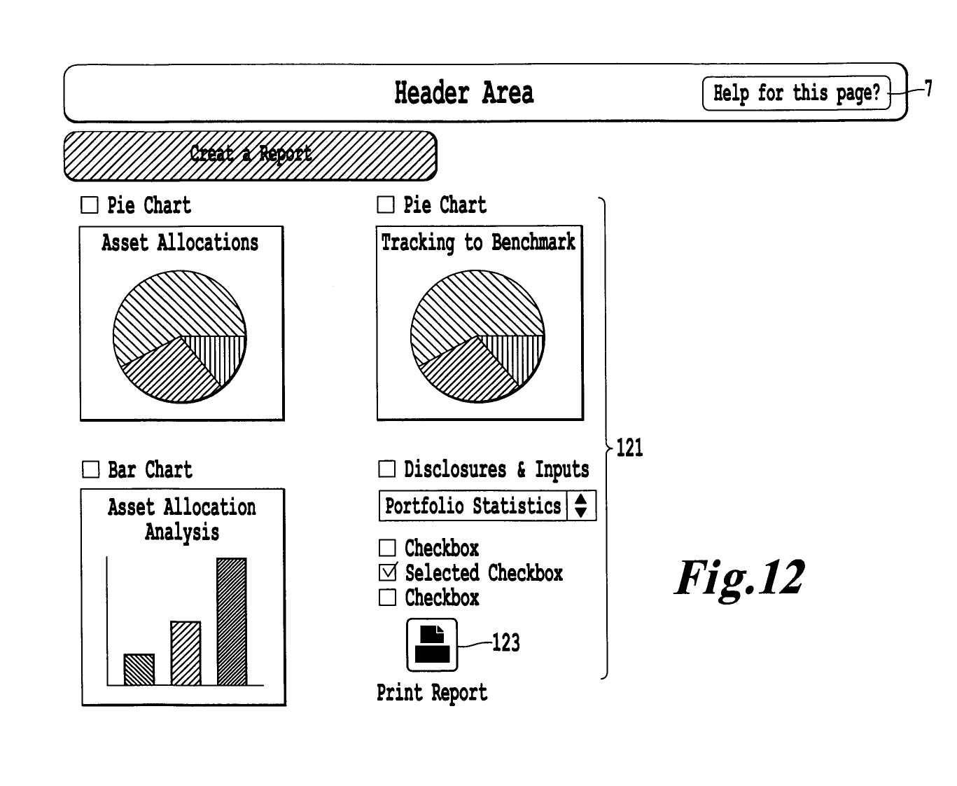

By clicking on a display allocation table link 83, the user will be brought to the page shown in FIG. 8 which displays the allocations for each selected mix along the efficient frontier 73. In this application, the terms portfolio allocation, allocation, portfolio, set and mix are all interchangeable terms and all refer to an allocated mixture of investments. Besides the “current” portfolio set used throughout the modules, the Reporting Module will refer to these portfolio allocations as Alt 1 (alternative 1), Alt 2, Alt 3, etc., and the Portfolio Builder Module will refer to them as Mix 1, Mix 2, etc. to distinguish which module is being used. By clicking on the display portfolio statistics link 85, the page shown in FIG. 9 will be displayed. When the user clicks on the display expected return graph link 87, the page shown in FIG. 10 will be displayed. When the user clicks on the disclosures/inputs link 89, the page shown in FIGS. 11A-C will be displayed. When the user clicks on the create a report link 91, the page shown in FIG. 12 will be displayed. By clicking on the export results to gap analysis link 93, the user will be brought to a main screen of the Gap Analysis Module which will have introductory text/information as well as an educational video or other information on how to use the system.

FIG. 8 is a page in the Portfolio Builder Module that displays the allocation results. The user will again have an opportunity to change the time horizon by selecting an amount of years in the drop box of the time horizon selector 79. FIG. 8 also displays an asset allocation chart 95 that is a chart that indicates the resulting suggested asset allocations. In FIG. 8, when the user selects one of the columns entitled: Current, Mix 1, Mix 2, Mix 3, and Mix 4 from the column select menu 97, the selected asset mixture will be displayed in a selected result pie chart 99 to the right of the asset allocation chart 95. It is possible for the selected result pie chart 99 to be displayed at a different location or in a separate window or page.

FIG. 9 is a page in the Portfolio Builder Module that displays portfolio statistics. In FIG. 9, the user will again have an opportunity to change the time horizon by selecting an amount of years in the drop box of the time horizon selector 79. FIG. 9 includes a portfolio statistics chart which provides the user with several areas of information including, but not limited to: the expected return of the portfolio over a one-year period and over the time horizon, a risk metric (may be standard deviation, sharpe ratio, information ratio, up-down capture, K-ratio, R², etc.) over a one-year and time horizon period, the best case and worst-case expected returns over one year and the time horizon, and other statistics that may be of value to the user. For example, the probability of achieving the target return over a one-year period and over the time horizon, the probability of achieving a negative return over a one-year period and over the time horizon, and benchmark tracking over a one-year period and over the time horizon.

FIG. 9 shows a current portfolio drop-down menu 103 which allows the user to select which column among the Current column, Mix 1 column, Mix 2 column, Mix 3 column, and Mix 4 column will be reflected in graph 105. Graph 105 depicts the best-case return, the worst-case return, and the expected return over a one, three, five, and ten year time period. It is possible that the specific time periods selected by the system are dependent on the time horizon. For a 10 year time horizon, the time periods could be, for example, 1 year, 3 years, 5 years, and 10 years. For a 20 year time horizon, the time period could be, for example, 1 year, 5 years, 10 years, and 20 years.

A time period drop-down menu 107 allows the user to select the time period that is reflected in graph 109. The time period that is reflected in the graph 109 can be from one year up to the time horizon selected in the time horizon selector 79. Graph 109 depicts the best-case return and worst-case return in likely returns for all of the mixes. The mixes will be along the horizontal axis of graph 109 with the return amount along the vertical axis of graph 109. The current mix will be located based on the current mix results.

FIG. 9 also shows an export to gap analysis link 111 at the bottom of the page that allows the allocations of FIG. 9 to be available and utilized in the gap analysis module. Lastly, FIG. 9 shows a report link 113, which when selected by the user, brings the user to FIG. 12.

FIG. 10 is a page in the Portfolio Builder Module that displays expected returns over the time horizon. The user will again have an opportunity to change the time horizon here using the time horizon selector 79. The displayed number of years drop down menu 113 is a drop down menu that allows a change in functionality of the graph 115 displayed below. FIG. 10 shows a graphical representation of the expected returns as also shown in graph 109 of FIG. 9. The graph 115 shows the expected returns of several different investing strategies, i.e. active, conservative, moderate, growth, aggressive, etc. FIG. 9 may also include a drop down menu that allows for a variety of graphical representations to be displayed. FIG. 10 shows the most likely (expected) return using a 10 year time horizon and showing the expected return for the entire 10 year period. FIG. 10 graphically displays some of the data shown in FIG. 9 to the user.

FIGS. 11A-C show a page in the Portfolio Builder Module that displays disclosures and inputs. By clicking on an override checkbox 117, the user will have an opportunity to override the built-in allocation constraints and modify the allocation constraints to their liking. Table 119 displays the input data used to create the displayed results of the Portfolio Builder Module. It is also possible for the page shown in FIGS. 11A-C to display disclosures typical to the securities industry and these functions.

FIG. 12 is a page in the Portfolio Builder Module where customized reports can be created by the user. In display area 121, the user can select what objects and information they want to include in a printed report. The page or pages can be, for example, pre-built in as templates based on what information the user wants to be included in the printed output. By clicking on the print report button 123, a PDF of the report is displayed which then could be printed. The report could be in a file format other than PDF.

An example of how the Portfolio Builder Module is used will be described next. Prior to using this module, certain educational materials (shown in FIG. 5) must be viewed. These modules are intended to provide assistance in understanding the basics behind portfolio building and include, but are not limited to: Standard Deviation, Correlations, and Efficient Frontier. The user inputs the amount of years they have until retirement, selects a time horizon for evaluation (a minimum of 5 years, maximum of 25 years, defaulted based on years to retirement). Next, the user completes a Risk Tolerance Questionnaire shown in FIG. 6 to aid the user in determining their current risk tolerance. Based on the answers to these questions, allocation constraints that are built into the system will be automatically determined. These constraints will require certain asset classes or asset class categories to be subjected to minimum and maximum percentages. For example a particular asset class, such as equities, may be required to be part of the portfolio in an amount between a minimum percentage of 10%, for example, and a maximum percentage of 60%, for example.

Based on the assets that are allowed to be used by the system, and allocation constraints developed by a combination of the risk tolerance questions and the age to retirement, an efficient frontier is developed which provides an unlimited number of allocation possibilities along the frontier spectrum. An exemplary efficient frontier is shown in FIG. 7. As the user slides along the efficient frontier using a mouse or other input device (e.g. touchscreen, tracking ball, etc.), the respective allocation is displayed as a pie chart. The user functionally elects between three and five allocations by clicking on the mouse or hitting the space bar, for example. Once allocations are elected, the user can see a chart of the allocations in FIG. 8, as well as the forecasted return and risk expectations for the current allocation and the Mix's selected in FIG. 9. The statistical data which may include (all items may be represented in a one year period as well as over the time horizon): expected return, expected risk, best case return, worst case return, probability of target, probability of negative return, and tracking analysis.

### The Custom Target Date Module

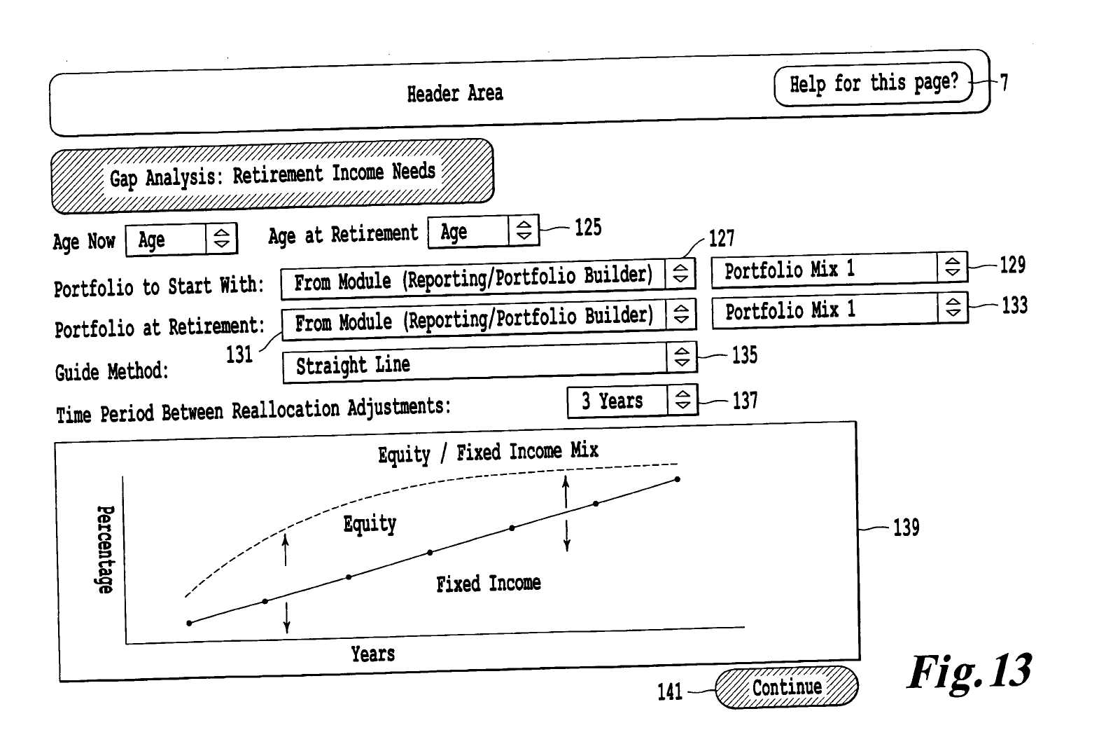

FIG. 13 is a data input page of another module, the Custom Target Date Module. At age input fields 125, the user will input their current age and their desired age at retirement. Next, using module selector 127 and portfolio selector 129, the user selects a portfolio to begin the glide path with. The user may first select from either the Reporting Module or the Portfolio Building Module. Then using the portfolio selector 129, the user picks which portfolio they want (may use Current, Alt 1, Alt 2, etc. from the Report Builder or Mix 1, Mix 2, etc. from the Portfolio Builder).

Using the module selector 131 and the portfolio selector 133, the user will select a portfolio to end the glide path with. Using the module selector 131, they may select from either the Reporting Module or the Portfolio Building Module from the drop down menu. Next, the user will select a particular portfolio from the portfolio selector 133 from the drop down menu. Using a glide method selector 135, the user can select the glide path to be a straight line glide path or may select the glide path to deviate more conservatively or more aggressively via a drop down menu.

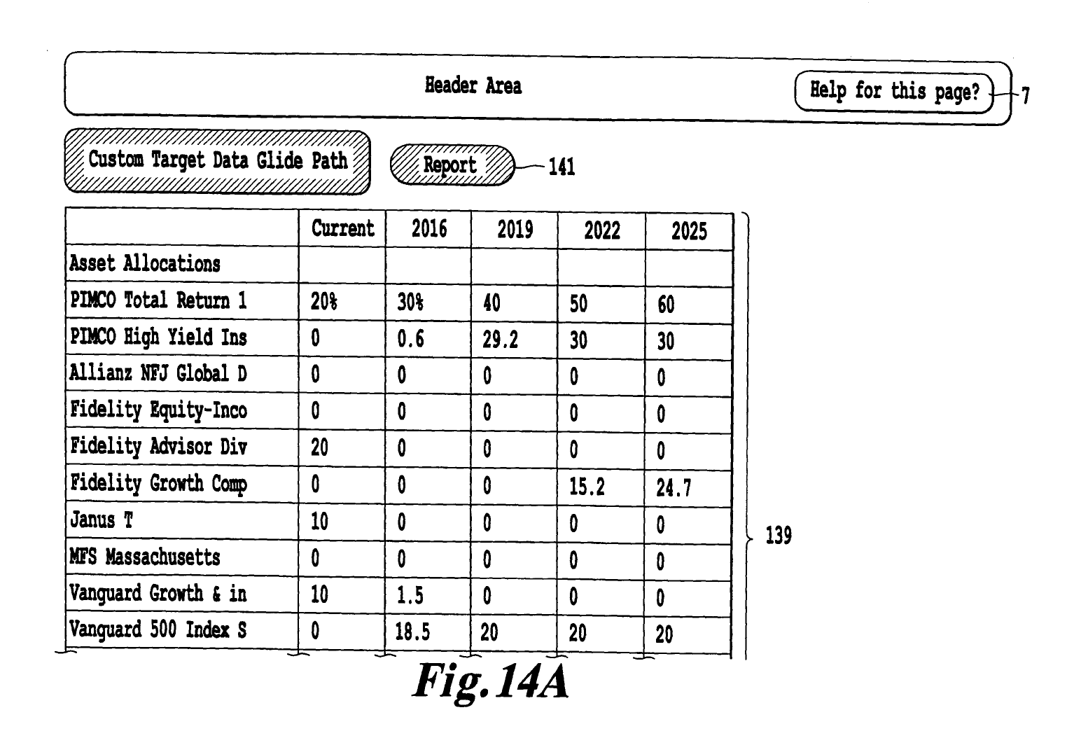

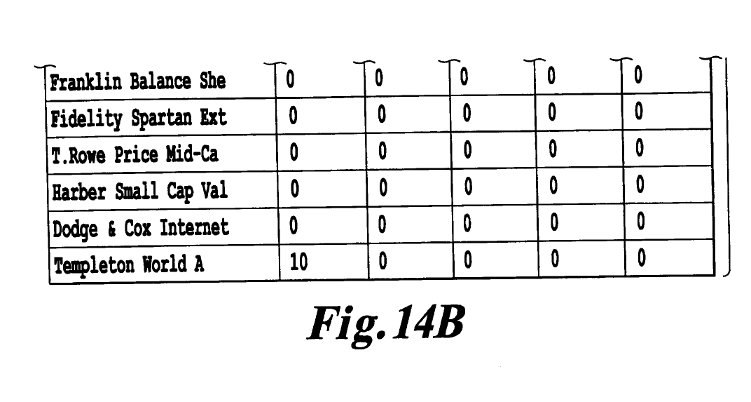

A reallocation adjustment menu 137 allows the user to elect how often adjustments to the allocation should be made. The allowable entries that are displayed to the user in the menu 137 are determined by the system based on the number of years between the present time and the time of retirement. Equity/fixed income chart 139 shows how equities would decrease and fixed income would increase over the time horizon. Lastly, FIG. 13 includes a report link 141, which, when selected by a user, brings the user to the page shown in FIGS. 14A-B.

FIGS. 14A-B show a page in the Custom Target Date Module that displays results based on the inputs entered into the page shown in FIG. 13. FIGS. 14A-B include a chart 139 that is displayed in order to show how the allocations would be modified over the desired time horizon. The chart 139 shown in FIGS. 14A-B includes a first column showing the starting allocation of assets based on elections made in FIG. 13, by the module selector 127 and the portfolio selector 129. The second column of the chart 139 shows the allocation of assets at the first calendar year of changes based on what was inputted into the reallocation adjustment menu 137, added to the present year. The third column of chart 139 shows the allocation of assets at the subsequent calendar year of changes based on the input of the reallocation adjustment menu 137 added to the prior changed year. The fourth column of chart 139 shows the allocation of assets at the third calendar year of changes. These columns will continue until all changes are represented. When the user selects the print link 141, the report of FIGS. 14A-B can be printed.

An example of how the Custom Target Date Module is used will be described next. First, the user selects the portfolio to start with using the module selector 127 and the portfolio selector 129. The user will then select the portfolio at retirement using the module selector 131 and the portfolio selector 133. Next, the user selects the years to glide, which is determined based on the user's current age and their age at retirement.

The user selects a straight line approach (shown in graph 139 of FIG. 13) or “skewing” based on the risk tolerance answers obtained in the Portfolio Builder Module (e.g. a more aggressive approach glides more, a more conservative approach slopes more). The risk tolerance questions and the user's age to retirement are utilized in the Portfolio Builder Module to assign pre-built constraints based on personalized risk tolerance. If utilizing the Portfolio Builder Module's Mixes—these risk tolerances are considered in the development of portfolios, but if using the Report Builder Module's Alt's—risk tolerance is not considered. For example, it would not be uncommon for a younger investor to believe that they can hold a more aggressive stance longer than usual (or longer than straight line) and an older investor may want to get more conservative quicker in order to protect his assets. Slopes in target date fund (TDF) glide paths are common and differ greatly from company to company. With the user building their own glide path, they can create a slope according to their own desires.

The system creates an annual rebalancing pattern based on selections when there are five or less years to retirement, a bi-annual rebalancing pattern for up to sixteen years to retirement, and 8 reallocations when retirement is more than sixteen years away.

### The Gap Analysis Module

FIG. 15 shows a first input page of the Gap Analysis Module. At the first row 143 of the chart shown in FIG. 15, the user will input the current balance of their 401(k), the annual amount that is being saved in their 401(k), indicate if the amount being saved is to be inflated or not, and input the assumed tax rate pre-retirement and the assumed tax rate post-retirement. The pre-retirement tax rate will be defaulted to 0% and the post-retirement tax rate will be defaulted to 25%. It is possible that these tax rates are defaulted to other percentages and that the user can modify these percentages to the tax rates. At the second row 145 of the chart shown in FIG. 15, the user will import the current balance of their IRAs, the amount being saved annually in their IRAs, indicate if the amount being saved is to be inflated or not, and enter the pre-retirement and post-retirement tax rates. The pre-retirement tax rate will be defaulted to 0% and the post-retirement tax rate will be defaulted to 25%. Again, it is possible that these tax rates are defaulted to other percentages by the system automatically at some future time, however, the user will always be able to override the default tax rates.

Next, at the third row 147 of the chart shown in FIG. 15, the user will input the current value and the amount saved annually in any Roth IRAs, indicate if the amount being saved is to be inflated or not, as well as the pre-retirement and post-retirement tax rates. The pre-retirement tax rate will be defaulted at 25%, and the post-retirement tax rate will be defaulted to 0%. Again, it is possible that these tax rates are defaulted to other percentages. At the fourth row 149 of the chart, the user will input the current value and amount saved annually in nonqualified annuities, and indicate if the amount being saved is to be inflated or not. The pre-retirement and post-retirement tax rates will be defaulted to 25%.

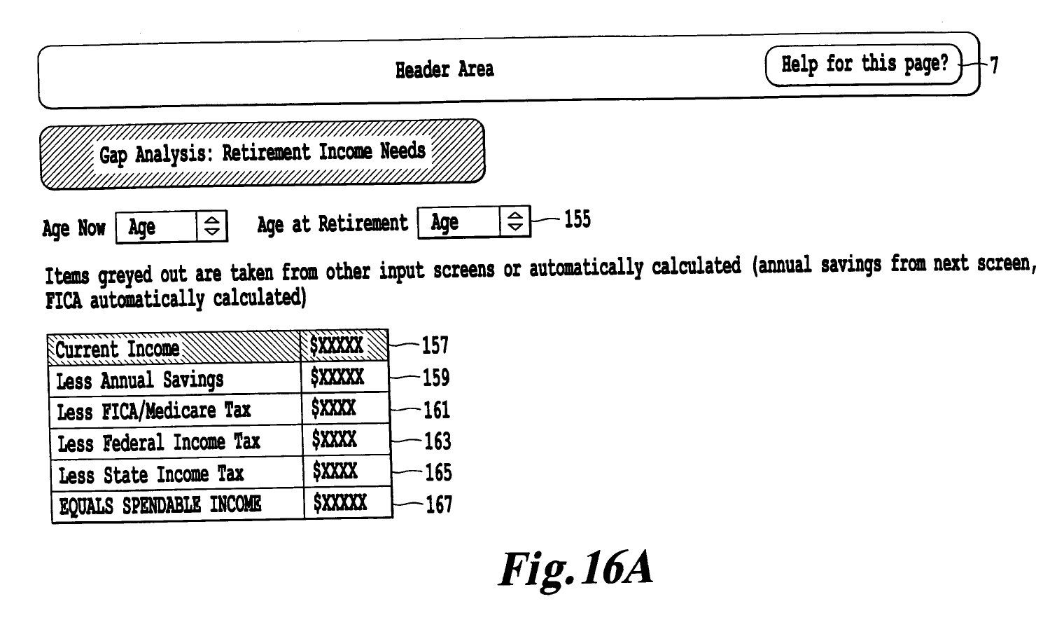

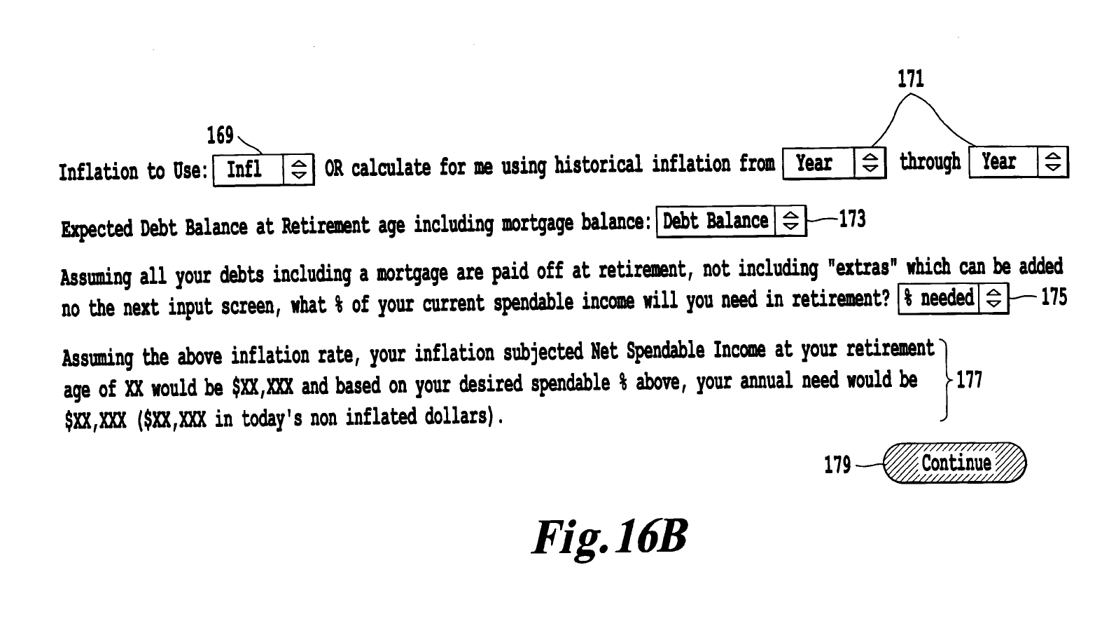

At the fifth row 151 of the chart, the user will input the current value and annual savings for all other investments and indicate if the amount being saved is to be inflated or not. The pre-retirement and post-retirement tax rates will be defaulted to 20% to take into account the possibility of a lower long-term capital gains tax rate. FIG. 15 also includes a continue link, which when clicked by the user, takes the user to the page shown in FIG. 16.

FIGS. 16A-B show a second input page of the Gap Analysis Module. The user will input their current age and the age at retirement at the age input fields 155. These fields will be interchangeable with the age input fields 125 in FIG. 13 so that the data that was already inputted at the screen of FIG. 13 would be automatically populated in FIGS. 16A-B, and if the age information is inputted at age input fields 155 of FIG. 16A, the data would later be available on page 13 at age input fields 125. At current income field 157, the user will input the current annual income. The system will automatically input the combined annual savings amount taken from FIG. 15 into the annual savings field 159. At the FICA/Medicare tax field 161, the system will calculate FICA and Medicare taxes based on the income displayed at the current income field 157 on the display page of FIG. 16A. At federal income tax field 163, the user will input their annual federal income tax as shown on their federal tax return. Next, at the state income tax field 165, the user will input their annual state income tax as shown on their state tax return. Based on the figures present at fields 157, 159, 161, 163, and 165, the system will calculate the net spendable income and display the net spendable income at spendable income field 167.

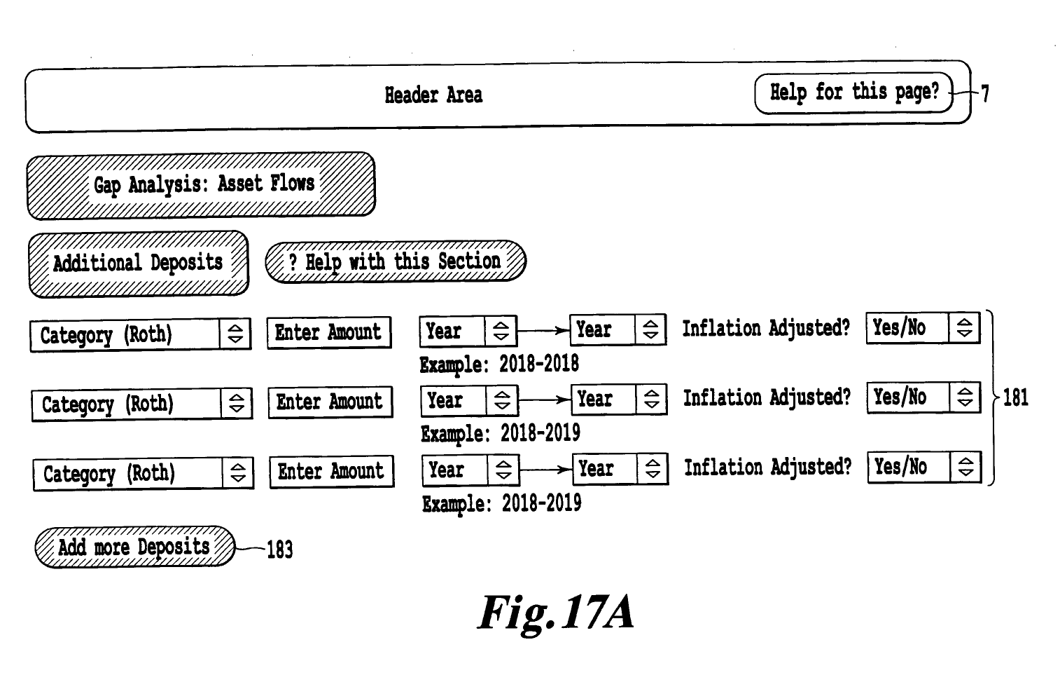

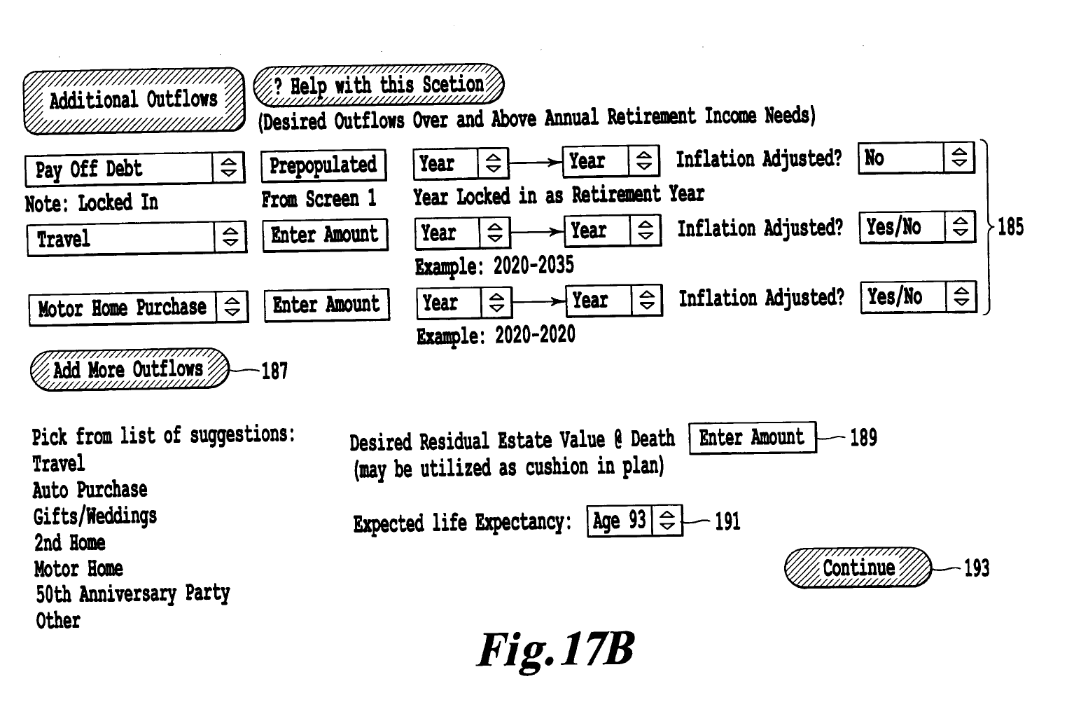

FIGS. 16A-B also include an inflation selector 169, which allows the user to input a desired inflationary rate, or the user can input the beginning year and ending year into year fields 171 for the system to calculate the historical inflation rate, which will then be used as the inflation rate. At debt balance field 173, the user inputs the amount of debt they expect to have at retirement age. The system will assume that the expected debt balance will want to be paid at the time of retirement. At the percent needed field 175, the user will input the percentage of their spendable income they desire in retirement. As shown in FIGS. 16A-B, the user should assume that all debts will be paid. Based on the above information that is inputted into the various fields of FIG. 16, a message 177 is displayed that reflects the inflation-adjusted annual income amount desired at retirement, as well as that same value uninflated or in today's dollars. Lastly, a continue link 179 is displayed, and when this link is selected, the user will be brought to the screen shown in FIGS. 17A-B.

FIGS. 17A-B show a third input page of the Gap Analysis Module. FIG. 17A shows the upper portion of the page and FIG. 17B shows the lower portion of the page. In addition to the various savings reflected in FIG. 15, the user can indicate additional expected deposits in additional deposit fields 181. The user identifies where that additional deposit would be deposited (i.e. Roth, 401(k), Other, etc.), the amount to be deposited, the beginning year and ending year so if it were a single deposit it would say 2018-2018 for example, and indicate whether or not the dollar amount should be fixed or should be inflated. Also shown in FIG. 17A is an add more deposits link 183, which when clicked by the user adds more additional deposits than the three defaulted on the page. FIG. 17B includes additional outflow fields 185 in which the user can input additional expected cash outflows over and above the income needed in retirement. The first additional outflow is locked in for paying off debt and will be pre-populated from the entry of the debt balance field 173 shown in FIG. 16. Additional outflows may be entered for the purchase of a motorhome for example, a 50th wedding anniversary party, wedding gift, etc. As with the additional deposits, the user would identify the category, the amount, the range of years, and whether or not that amount is inflated.

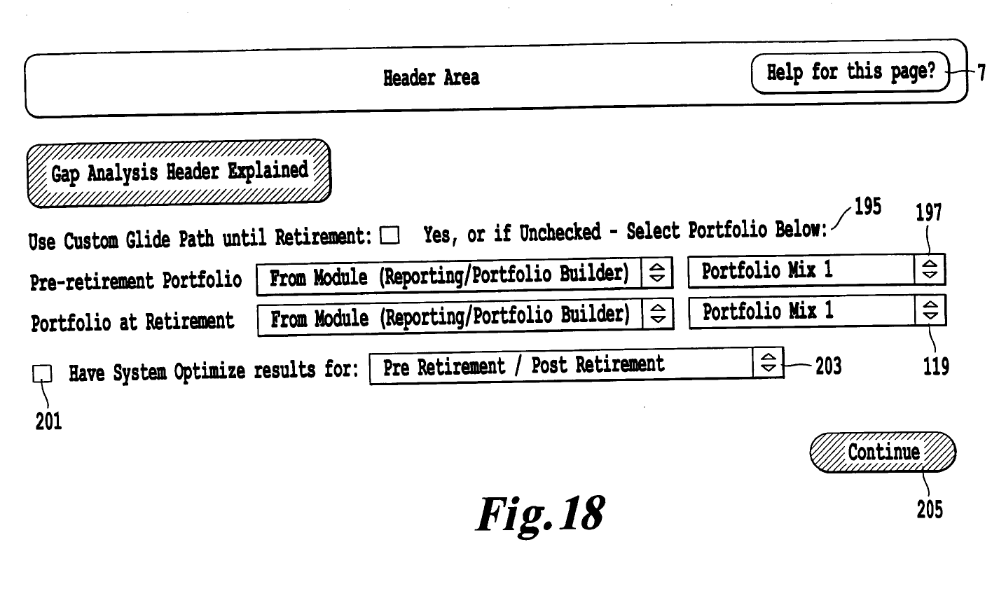

By clicking the add more outflows link 187, the user can add more additional outflows than the three defaulted on the page shown in FIG. 17B. At the estate value field 189, the user can enter a desired residual estate value at death. This amount can either reflect the desired estate to be transferred to others, or a desired cushion in the plan to increase the likelihood of success, or a combination of both. Also shown in FIG. 17B is a life expectancy selector 191, in which the user selects an age of life expectancy. The system will default to a life expectancy of age 93, however the user may override the defaulted value. Lastly, by clicking on the continue link 193, the user will be brought to the page shown in FIG. 18.

FIG. 18 shows a portfolio elections page of the Gap Analysis Module. FIG. 18 includes a glide path checkbox 195, which when checked by the user elects the use of the pre-retirement portfolio and/or post-retirement portfolio resulting from the Custom Target Date Module shown in FIG. 13. If the glide path checkbox 195 is not checked, the user would select a portfolio to use pre-retirement by first identifying what module to use: Reporting Module or Portfolio Builder Module, and which portfolio to utilize from the respective module by using the pull-down menus of the pre-retirement portfolio menus 197. At the retirement portfolio menus 199, the user selects a portfolio to use post-retirement by identifying what module to use: Reporting Module or Portfolio Builder Module, and which portfolio to utilize from the selected module.

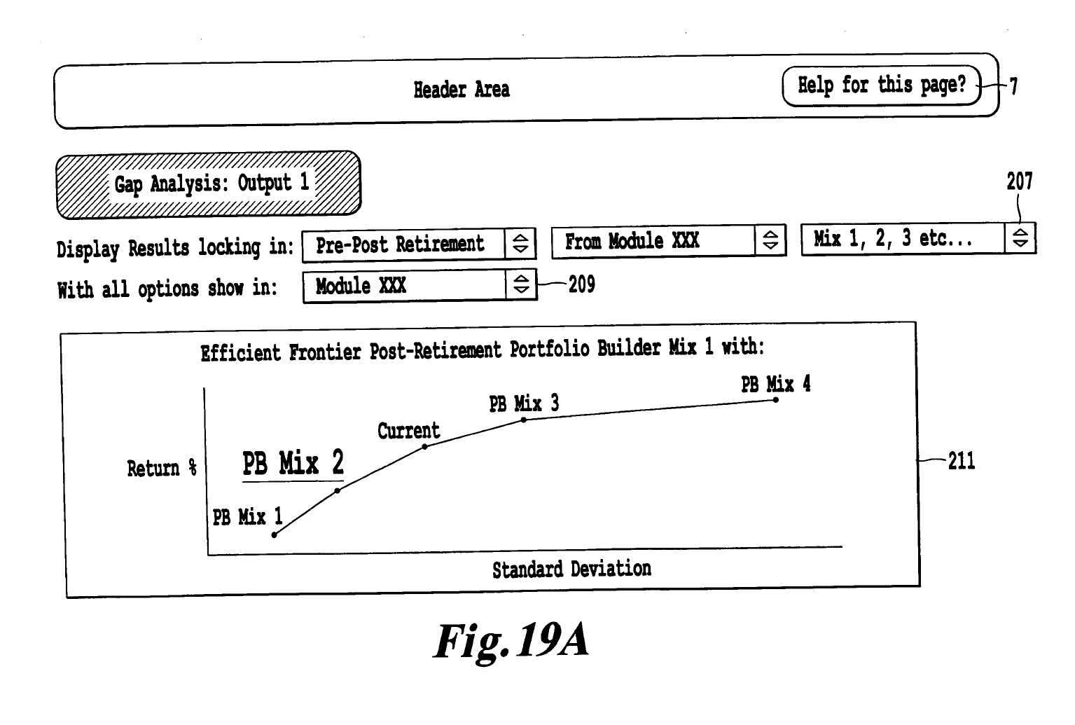

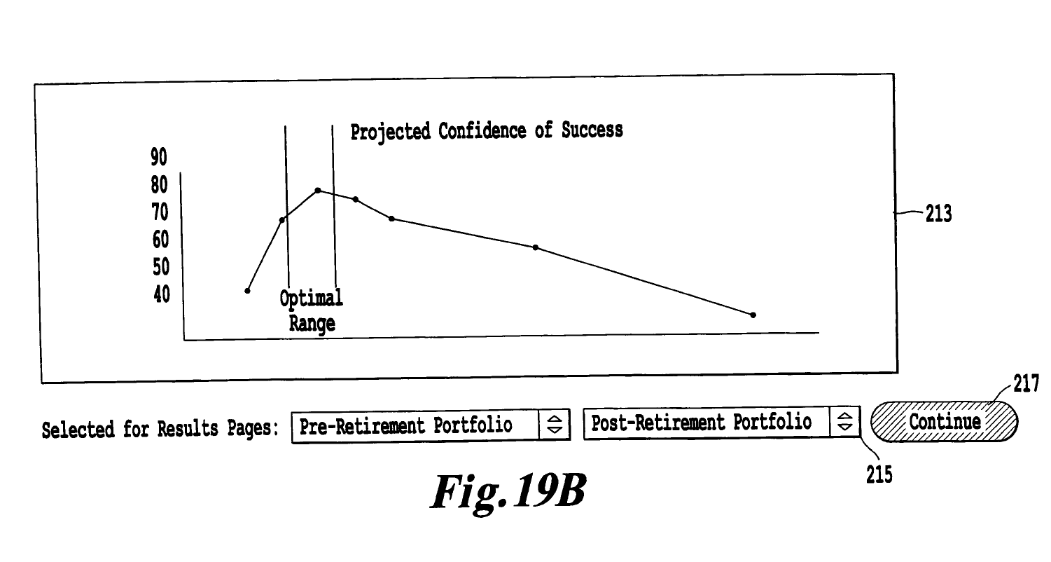

FIG. 18 also displays a system optimization checkbox 201, which when checked by the user, causes the system to automatically determine, by the use of a computer processor, the optimal pair of pre-retirement portfolio and post-retirement portfolio. For example, if the user has elected to have the system optimize results for post-retirement from the pull down menu 203, the system will go through all allocations in the Reporting Module and all allocations in the Portfolio Builder Module to determine which of those portfolios generates the greatest likelihood of success in reaching the desired goals of the user when paired with the elected pre-retirement allocation. If the user has elected to have the system optimize results for pre-retirement from the pull down menu 203, the system will go through all allocations in the Reporting Module and all allocations in the Portfolio Builder Module to determine which of those portfolios generates the greatest likelihood of success in reaching the desired goals of the user when paired with the elected post-retirement allocation. The system will then output the results for the user. If the user elects to use the custom glide path pre-retirement, the system can only optimize which post-retirement portfolio to use. Lastly, FIG. 18 includes a continue link 205, which when clicked by a user, causes the user to be taken to the page shown in FIGS. 19A-B.

FIGS. 19A-B show an output page of the Gap Analysis Module. The system will perform the analysis using one pre-retirement portfolio (or perhaps a custom glide path), and one post-retirement portfolio which are selected using input fields 207. The screen displayed in FIGS. 19A-B reflects the pairing of one allocation either pre or post-retirement with all others of the opposite. (i.e. Select Mix 1 post-retirement, and the displayed results are for Mix 1 post retirement (locked in) with pre-retirement current, Mix 1, Mix 2, Mix 3, Mix 4, etc). Using module selector 209, the user selects to pair the one selected choice with the options in either the Reporting Module or the Portfolio Builder Module by selecting either the Reporting Module or the Portfolio Builder Module from the drop down menu. Efficient frontier graph 211 shown in FIG. 19A displays the results of the efficient frontier for the locked-in portfolio, along with the unlocked grouping of portfolios. By use of a “Monte Carlo” simulation of success, the projected confidence of success graph 213 indicates the projected confidence of success by percentage and is directly tied to the efficient frontier graph directly above it. The efficient frontier graph 211 and the projected confidence of success graph 213 will identify the area showing the most likely success in the “optimal range area,” which is automatically generated by the system and displayed on the projected confidence of success graph 213. Using the two portfolio selectors 215, the user will then confirm the portfolio pairing to be utilized for the next results pages. For example, the user will select the pre-retirement portfolio and the post-retirement portfolio that created the results that best suit their needs. Once the user has selected the appropriate pre-retirement portfolio and post-retirement portfolio using the portfolio selectors 215, the user clicks on the continue link 217.

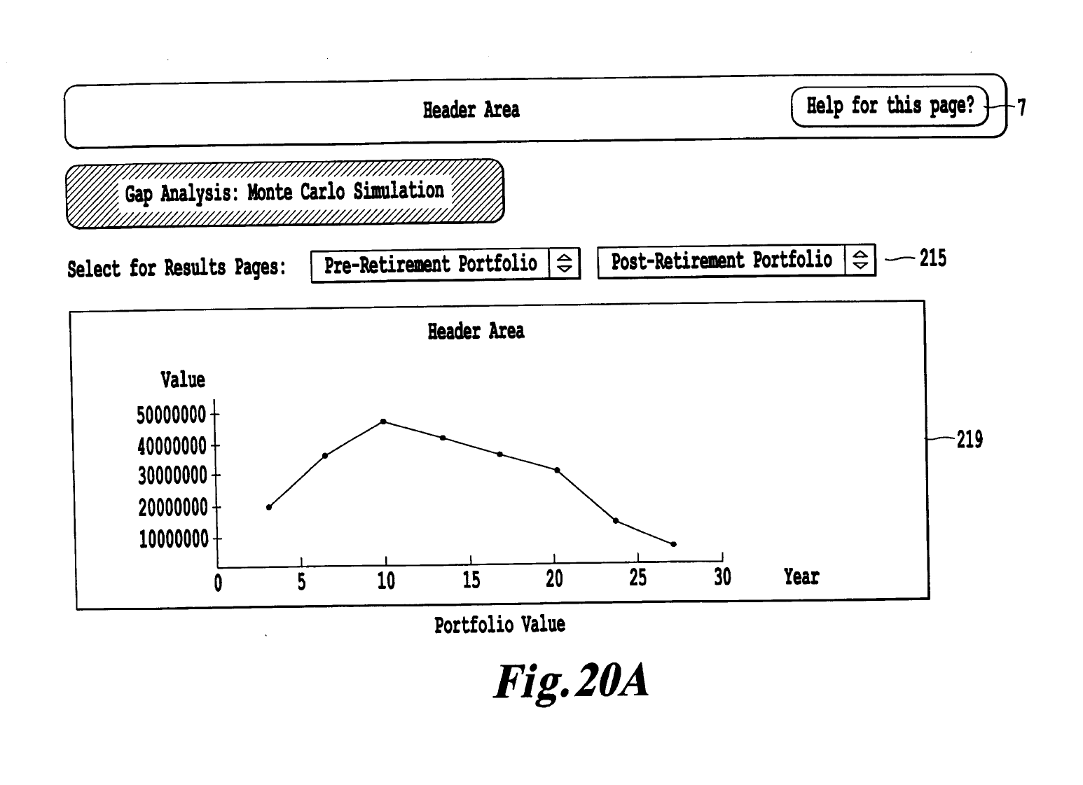

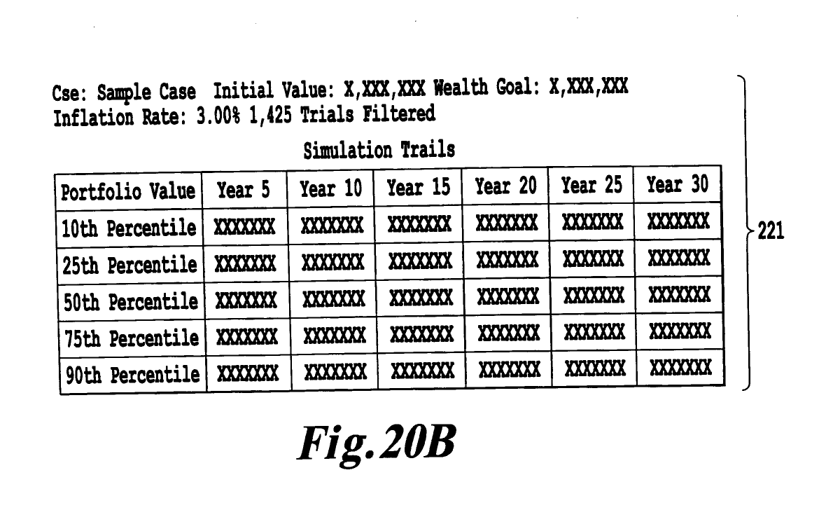

FIGS. 20A-B show a page in the Gap Analysis Module that displays Monte Carlo results. FIG. 20A displays to the user in the two portfolio selectors 215, the names of the pre-retirement and post-retirement portfolios that are being utilized. The results are shown below the displayed names of the selected pre-retirement and post-retirement portfolios. The user will have the ability to modify the results that are displayed by selecting alternative portfolios. FIG. 20A also includes a portfolio value graph 219. Taking into account the return and risk metrics of the elected pre and post retirement allocations, and through use of a Monte Carlo simulator, the portfolio value graph illustrates the expected portfolio value over time based on all the input criteria utilized. The vertical axis of the portfolio value graph 219 is an amount of dollars (however, it could be any other currency unit) and the horizontal axis is an amount of time in years (could also be months, days, etc.). Simulation trials chart 221 shows results based on the Monte Carlo simulation that was run. The columns of the simulation trials chart 221 are various times in years, and the rows of the chart are various percentiles. Each intersection of a column and row shows a portfolio value for the particular column (year) and particular row (percentile).

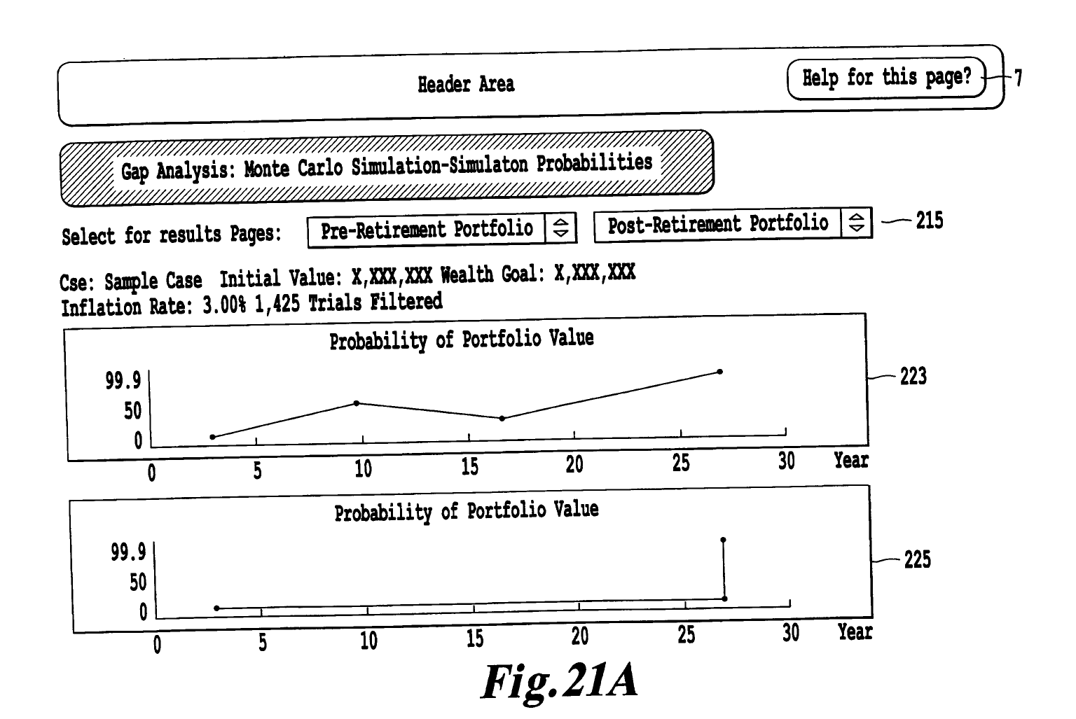

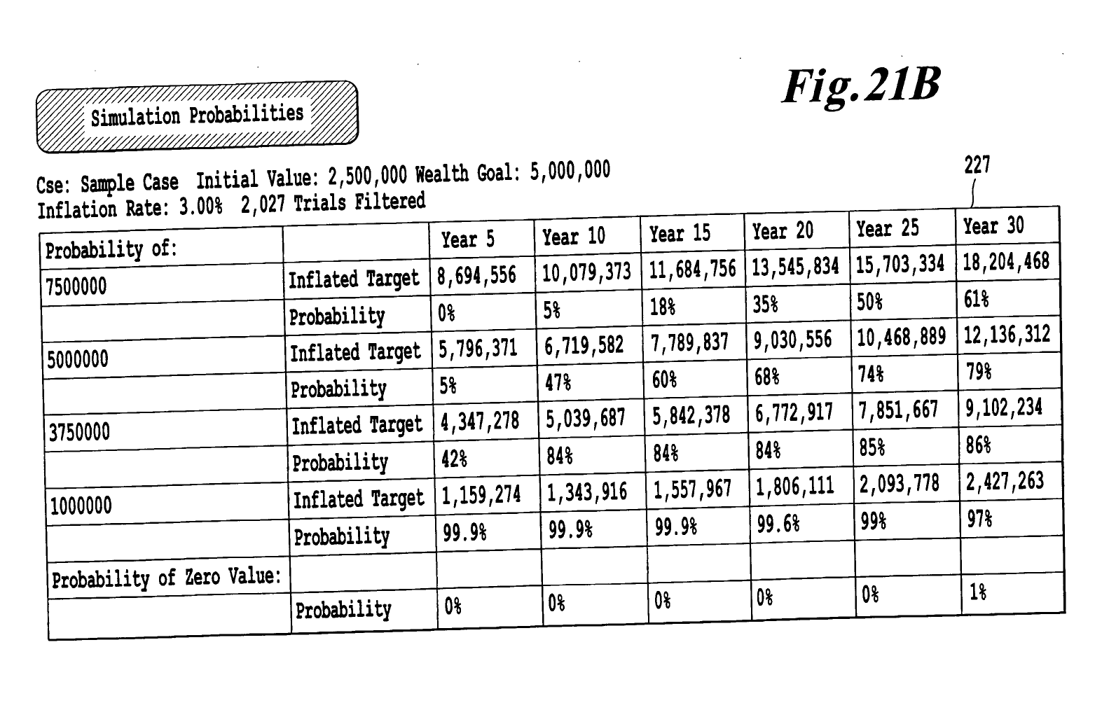

FIGS. 21A-B show a page in the Gap Analysis Module that displays a second page of Monte Carlo results. Several Monte Carlo simulations and simulation probabilities are displayed. As in FIGS. 20A-B, FIG. 21A displays to the user in the two portfolio selectors 215, the names of the pre-retirement and post-retirement portfolios that are being utilized and the results are shown underneath the portfolio selectors 215. The user will have the ability to modify the results by selecting alternative portfolios with the two portfolio selectors 215. A Probability of Portfolio Value Graph 223 illustrates the probability of the portfolio value shown. In FIG. 21A, the sample case displayed above the Probability of Portfolio Value graph 223 reflects some of the data used (initial value, wealth goal (meaning desired residual value), inflation rate, etc.). So graph 223 shows the probably of hitting that specific residual value that was input. Also, in FIG. 21A, a Probability of Zero Value Graph 225 illustrates the probability that the portfolio will have zero value. This graph 225 indicates the likelihood of running out of money completely (not hitting residual, but actually $0 value) over a period of time. Simulation Probabilities Chart 227 illustrates the probability of certain residual values of the portfolio. The simulation probabilities lower below reflect the probability of hitting various other residual amounts after inflation and over various time periods.

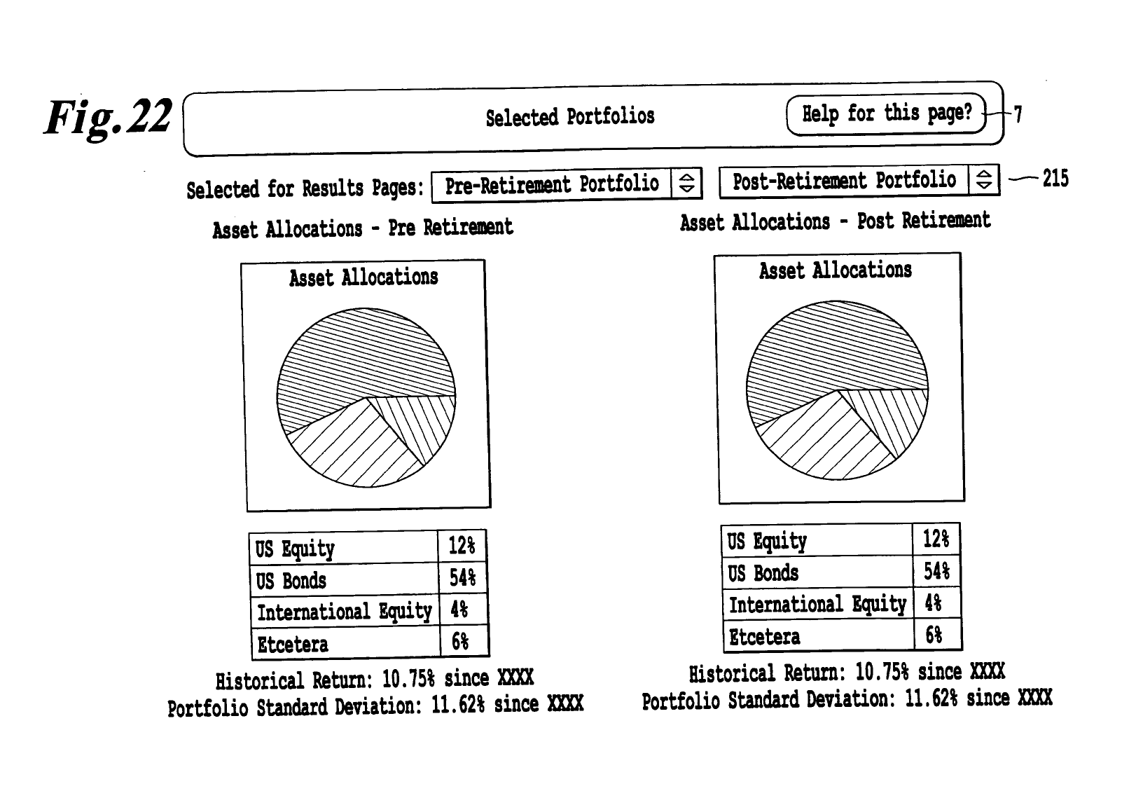

FIG. 22 is a page in the Gap Analysis Module that displays the portfolios that are utilized. FIG. 22 will display to a user the pre-retirement and post-retirement portfolios that are being utilized and the results of these portfolios are shown below. The user will have the ability to modify the results that are displayed by selecting alternative portfolios using the two portfolio selectors 215. Displayed at a first area 229 is the pre-retirement portfolio used in the gap analysis in pie chart format, and also in table format. First area 229 also displays the historical return and standard deviation and/or other return and risk measures of the pre-retirement portfolio. Displayed at a second area 231 is the post-retirement portfolio used in the gap analysis in pie chart format, and also in table format. Second area 231 also displays the historical return and standard deviation and/or other return and risk measures of the post-retirement portfolio.

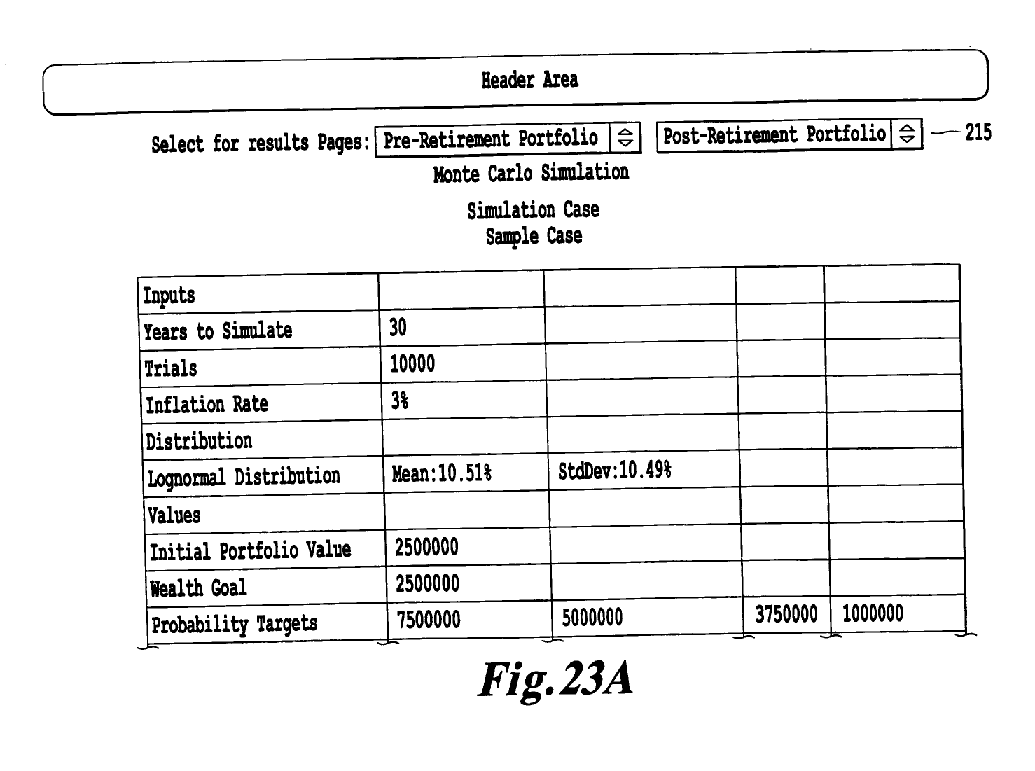

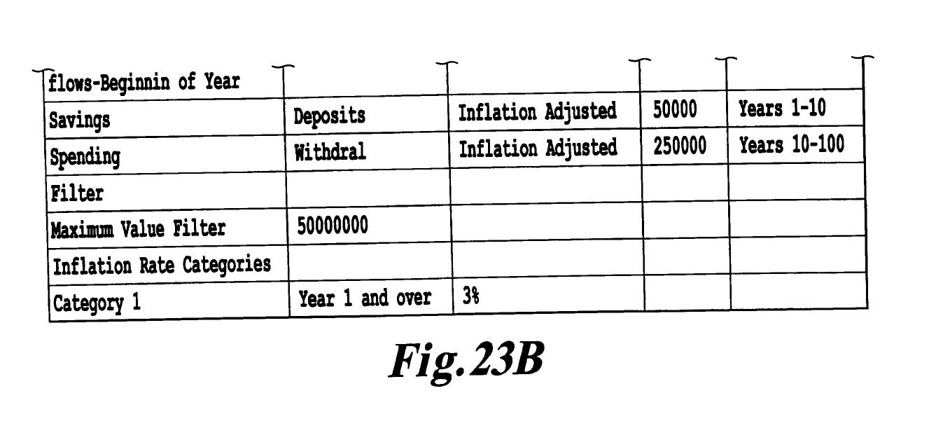

FIGS. 23A-B shows the last page in the Gap Analysis Module, and this page displays disclosures. FIGS. 23A-B include standard disclosures along with input data utilized to create the gap results. Examples of standard disclosures are that “results are not guaranteed” and that “past performance is not an indicator of future results,” etc. FIG. 23A also includes the two portfolio selectors 215 at the top of the page. FIGS. 23A-B also disclose the input data utilized in the simulation for compliance purposes.

An example of how the Gap Analysis Module is used will be described next. First, the user inputs the current values, annual savings, and pre-retirement and post-retirement tax rates for their 401(k), IRAs, Roth investments, and for all other accounts into rows 143, 145, 147, 149, and 151 shown in FIG. 15. Next, the user inputs their current age, and their retirement age into the age input fields 155 shown in FIG. 16. Next, the user inputs their current income into current income field 157, the system automatically calculates and displays annual savings, the system automatically calculates and displays FICA and Medicare tax at field 161, the user inputs the amount of federal and state income taxes paid at federal income tax field 163 and state income tax filed 165, and then based on the above information, the system then calculates and displays the net spendable household income at field 167.

In the next step, the user either inputs the inflation rate to use for the assumptions, or enters a historical time period for the system to calculate historical inflation from. The system then uses either the calculated inflation rate or the calculated historical inflation rate when performing the next calculations. Next, the user is prompted to enter the debt balance expected to remain at retirement inclusive of any mortgage balances. The user is then prompted to enter the percentage of spendable income required at retirement assuming all debts are paid off. The system calculates and generates a present value (i.e. non-inflated dollars), annual spending need, and inflated spending need. Next, the user is prompted to enter any additional cash inflows or outflows that may be expected/needed in addition to the annual savings already occurring or spending already accounted for. A predetermined additional cash outflow could be debt/mortgage repayment at retirement. If the user desires to leave an estate at death or otherwise just build a safety net or cushion into the plan, they are prompted to input this amount. The user is prompted to elect a pre-retirement portfolio and a post-retirement portfolio from either the Reporting Module or the Portfolio Builder Module. It is also possible to select the custom glide path from the Custom Target Date Module. The system may also automatically select either the optimum match to one selection, or an optimum pairing based on the greatest likelihood of success or some other criteria. After the portfolios are selected, graphs are displayed which represent the portfolio balance that is likely.

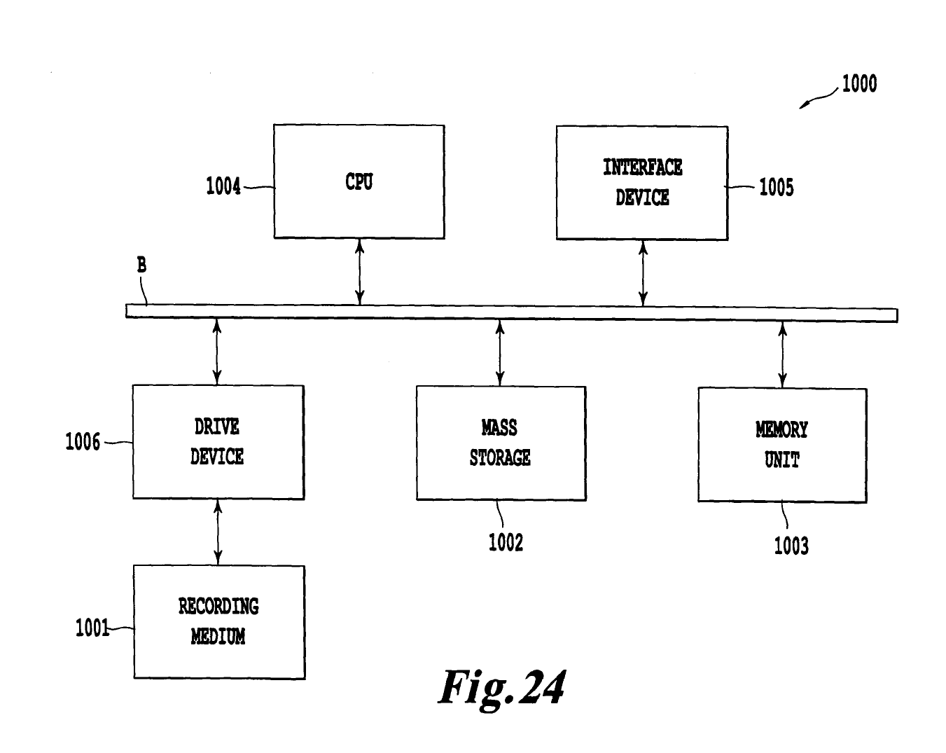

Turning now to FIG. 24, FIG. 24 shows an example of an information processing apparatus, which could be a computer, mobile phone device, tablet, etc. Certain portions of the processing, such as the determining of a risk tolerance level for the user based on the answers to the plurality of questions; determining of portfolio allocation constraints of the investment assets based on the current age value, the retirement age value, and the risk tolerance level; determining an efficient frontier based on the portfolio allocation constraints of the investment assets; and determining and displaying at least one risk statistic and at least one expected future return parameter for the selected mix of investment assets, can be implemented using some form of computer processor. As one of ordinary skill in the art would recognize, the computer processor can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog or any other hardware description language and the code may be stored in an electronic memory directly within the FPGA or CPLD, or as a separate electronic memory. Further, the electronic memory may be non-volatile, such as ROM, EPROM, EEPROM or FLASH memory. The electronic memory may also be volatile, such as static or dynamic RAM, and a processor, such as a microcontroller or microprocessor, may be provided to manage the electronic memory as well as the interaction between the FPGA or CPLD and the electronic memory.

Alternatively, the computer processor may execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OSX and other operating systems known to those skilled in the art.

In addition, certain features of the embodiments can be implemented using a computer based system (FIG. 24). The computer 1000 includes a bus B or other communication mechanism for communicating information, and a processor/CPU 1004 coupled with the bus B for processing the information. The computer 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 may be used for storing temporary variables or other intermediate information during the execution of instructions by the CPU 1004. The computer 1000 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer 1000 may also include a disk controller coupled to the bus B to control one or more storage devices for storing information and instructions, such as mass storage 1002, and drive device 1006 (e.g., floppy disk drive, read-only compact disc drive, read/write compact disc drive, compact disc jukebox, tape drive, and removable magneto-optical drive). The storage devices may be added to the computer 1000 using an appropriate device interface (e.g., small computer system interface (SCSI), integrated device electronics (IDE), enhanced-IDE (E-IDE), direct memory access (DMA), or ultra-DMA).

The computer 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer 1000 may also include a display controller coupled to the bus B to control a display, such as a cathode ray tube (CRT), for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer 1000 performs at least a portion of the processing steps of the invention in response to the CPU 1004 executing one or more sequences of one or more instructions contained in a memory, such as the memory unit 1003. Such instructions may be read into the memory unit from another computer readable medium, such as the mass storage 1002 or a removable media 1001. One or more processors in a multi-processing arrangement may also be employed to execute the sequences of instructions contained in memory unit 1003. In alternative embodiments, hard-wired circuitry may be used in place of or in combination with software instructions. Thus, embodiments are not limited to any specific combination of hardware circuitry and software.

As stated above, the computer 1000 includes at least one computer readable medium 1001 or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read.

Stored on any one or on a combination of computer readable media, the present invention includes software for controlling the main processing unit 1004, for driving a device or devices for implementing the invention, and for enabling the main processing unit 1004 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code elements on the medium of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU 1004 for execution. A computer readable medium may take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media may be involved in carrying out one or more sequences of one or more instructions to the CPU 1004 for execution. For example, the instructions may initially be carried on a magnetic disk of a remote computer. An input coupled to the bus B can receive the data and place the data on the bus B. The bus B carries the data to the memory unit 1003, from which the CPU 1004 retrieves and executes the instructions. The instructions received by the memory unit 1003 may optionally be stored on mass storage 1002 either before or after execution by the CPU 1004.

The computer 1000 also includes a communication interface 1005 coupled to the bus B. The communication interface 1005 provides a two-way data communication coupling to a network that is connected to, for example, a local area network (LAN), or to another communications network such as the Internet. For example, the communication interface 1005 may be a network interface card to attach to any packet switched LAN. As another example, the communication interface 1005 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1005 sends and receives electrical, electromagnetic or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc.). Moreover, the network may provide a connection to a mobile device such as a personal digital assistant (PDA) laptop computer, tablet, or cellular telephone.

While certain embodiments have been described, these embodiments have been presented by way of example only, and are not intended to limit the scope of the inventions. Indeed the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

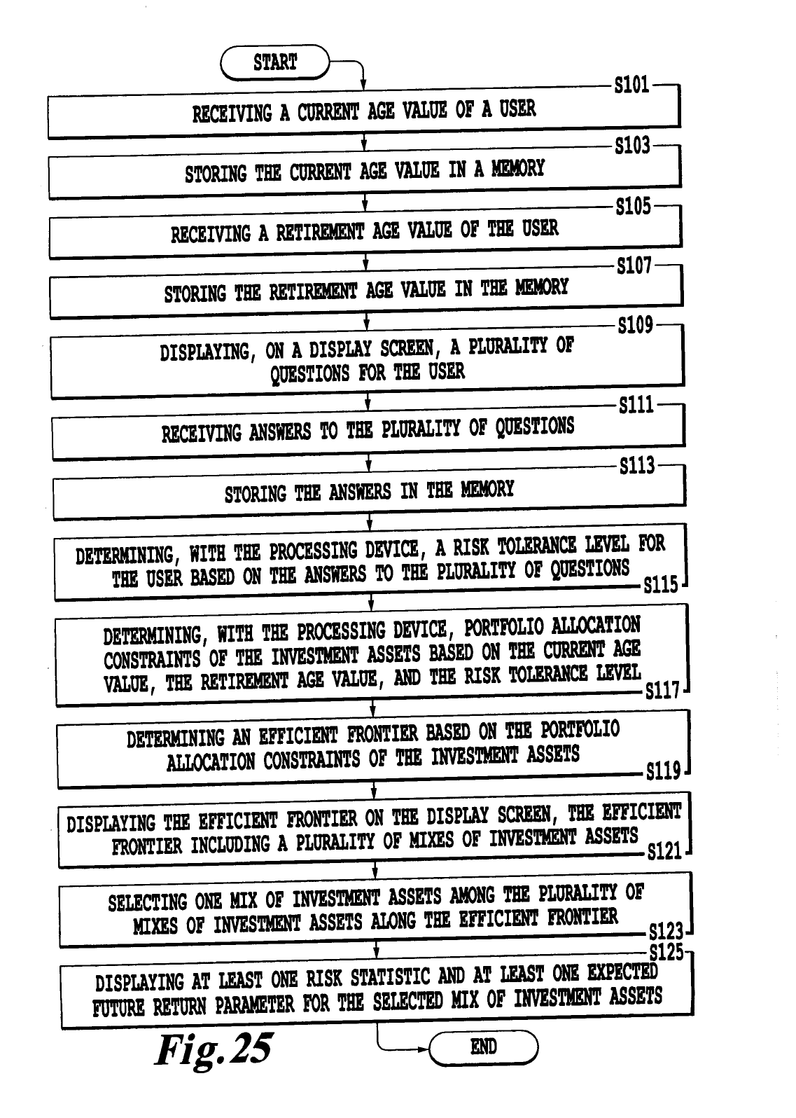

Turning now to FIG. 25, FIG. 25 shows a flow chart demonstrating a method performed in an embodiment of the present invention. In step S101, the system receives a current age value of a user that is inputted by a keyboard or other input device. In step S103, the system stores the current age value in a memory, for example mass storage 1002, memory unit 1003, or some other memory storage. In step S105, the system receives a retirement age value of the user that is inputted by the user or received in another manner. In step S107, the retirement age value is stored in a memory. This memory could be the same memory as in step S103 or a different memory. In step S109, a plurality of questions for the user are displayed on a display screen. Next, in step S111, the system receives answers to the plurality of questions. In step S113, the answers to the questions are stored in a memory. In step S115, a processing device, such as the CPU 1004 for example, determines a risk tolerance level for the user based on the answers to the plurality of questions. In step S117, the processing device of step S115, or some other processing device, determines portfolio allocation constraints of the investment assets based on the current age value, the retirement age value, and the risk tolerance level. In step S119, an efficient frontier is determined by a processing device based on the portfolio allocation constraints of the investment assets. Next, in step S121, the efficient frontier is displayed on the display screen, and the efficient frontier includes a plurality of mixes of investment assets. In step S123, the user selects one mix of investment assets among the plurality of mixes of investment assets along the efficient frontier. Lastly, in step S125, at least one risk statistic and at least one expected future return parameter for the selected mix of investment assets is displayed on the display screen.

Turning now to FIG. 25, FIG. 25 shows a flow chart demonstrating a method performed in an embodiment of the present invention. Step S127 shows a step of receiving a current age value of a user. Step S129 shows a step of storing the current age value in a memory. Step S131 shows a step of receiving a retirement age value of the user. Shown in S133 is a step of storing the retirement age value in the memory. Step S135 shows selecting a starting portfolio, that is a mix of investment assets, from a plurality of portfolios. Step S137 is a step of selecting an ending portfolio, that is a mix of investment assets, from the plurality of portfolios. Step S139 is a step of selecting a glide path profile from among a plurality of glide path profiles. Next, step S141 is a step of selecting an amount of time between reallocation of the investment assets. Step S143 is a step of determining, with a processing device, asset allocations of the investment assets at various times along the selected glide path profile based on the current age value of the user, the retirement age value of the user, the starting portfolio, the ending portfolio, the selected glide path, and the amount of time between reallocation. Lastly, step S145 is a step of displaying the asset allocations of the investment of assets at the various times.

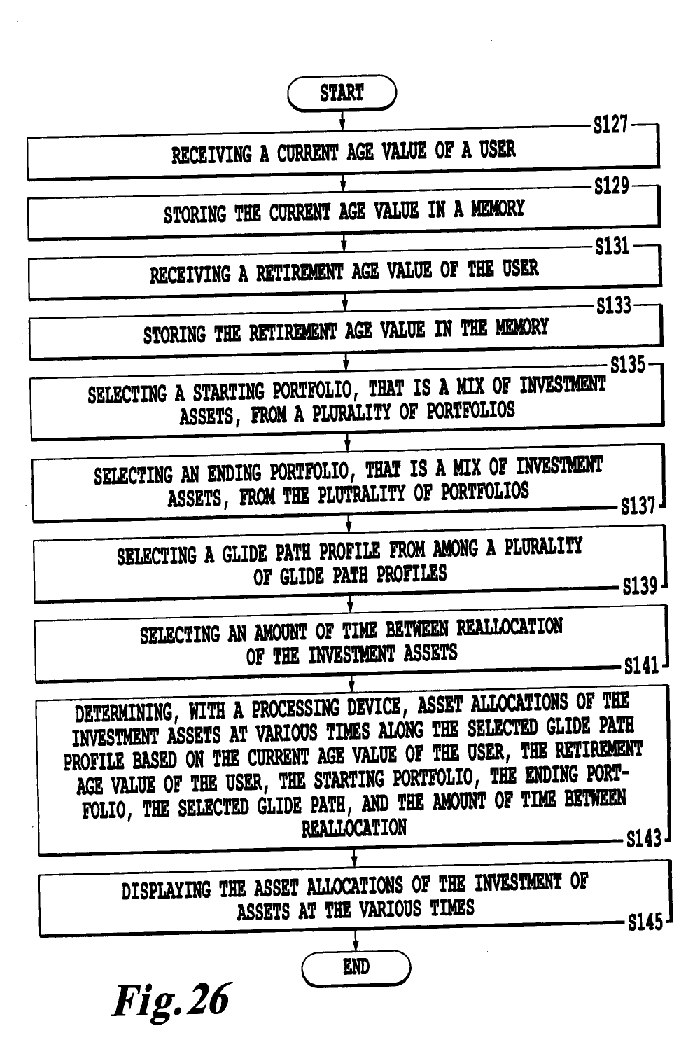

Turning now to FIG. 26, FIG. 26 shows a flow chart demonstrating a method performed in an embodiment of the present invention. Step S127 shows a step of receiving a current age value of a user. Step S129 shows a step of storing the current age value in a memory. Step S131 shows a step of receiving a retirement age value of the user. Shown in S133 is a step of storing the retirement age value in the memory. Step S135 shows selecting a starting portfolio, that is a mix of investment assets, from a plurality of portfolios. Step S137 is a step of selecting an ending portfolio, that is a mix of investment assets, from the plurality of portfolios. Step S139 is a step of selecting a glide path profile from among a plurality of glide path profiles. Next, step S141 is a step of selecting an amount of time between reallocation of the investment assets. Step S143 is a step of determining, with a processing device, asset allocations of the investment assets at various times along the selected glide path profile based on the current age value of the user, the retirement age value of the user, the starting portfolio, the ending portfolio, the selected glide path, and the amount of time between reallocation. Lastly, step S145 is a step of displaying the asset allocations of the investment of assets at the various times.

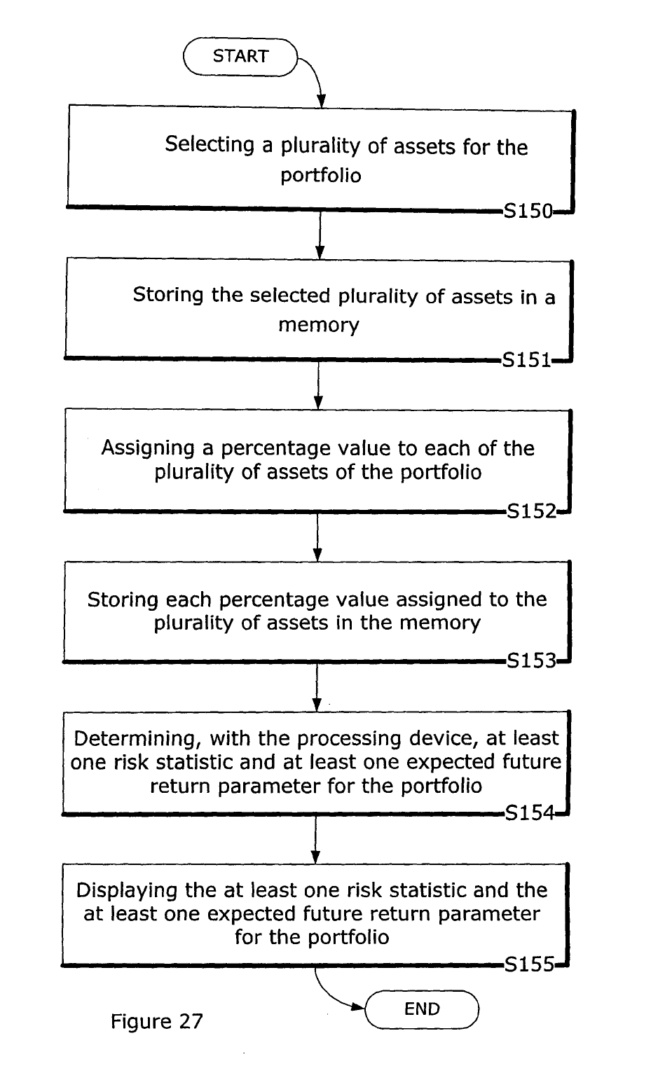

Turning now to FIG. 27, FIG. 27 shows a flow chart demonstrating a method performed in an embodiment of the present invention for allocating investment assets within a portfolio. Step 150 shows a step of selecting a plurality of assets for the portfolio. Step 151 shows a step of storing the selected plurality of assets in a memory. Step 152 shows a step of assigning a percentage value to each of the plurality of assets of the portfolio. Step 153 shows a step of storing each percentage value assigned to the plurality of assets in the memory. Step 154 shows a step of determining, with the processing device, at least one risk statistic and at least one expected future return parameter for the portfolio. Lastly, Step 155 shows a step of displaying the at least one risk statistic and the at least one expected future return parameter for the portfolio.

Obviously, numerous modifications and variations of the present invention are possible in light of the above teachings. It is therefore to be understood that within the scope of the appended claims, the invention may be practiced otherwise than as specifically described herein.

1-19. (canceled)

20. A method of allocating wealth to a plurality of investment assets for a portfolio, the method comprising:
selecting the plurality of investment assets for the portfolio;
storing the selected plurality of investment assets in a memory;
assigning a percentage value of a total value of the wealth to each of the plurality of investments assets of the portfolio;
storing each percentage value assigned to the plurality of investment assets in the memory;
determining, with processing circuitry, at least one risk statistic and at least one expected future return parameter for the portfolio based on the percentage value assigned to each of the plurality of investment assets for the portfolio;
displaying, on a display screen, the at least one risk statistic and the at least one expected future return parameter for the portfolio,
determining, with the processing circuitry, a plurality of portfolios, each of the plurality of portfolios including different percentage values of the total value of the wealth assigned to each of the plurality of investment assets;
displaying a corresponding risk statistic and a corresponding expected future return parameter for each of the plurality of portfolios on the display screen;
selecting at least one portfolio from among the plurality of portfolios; and
displaying a first risk statistic and a first expected future return parameter for each investment asset of a corresponding plurality of investment assets for the at least one selected portfolio.

21. The method of claim 20, wherein the step of selecting a plurality of assets for the portfolio further comprises:
receiving a current age value of a user, and storing the current age value in the memory;
receiving a retirement age value of the user, and storing the retirement age value in the memory;
selecting a starting portfolio from the plurality of portfolios including the portfolio;
selecting an ending portfolio from the plurality of portfolios;
selecting a glide path profile from among a plurality of glide path profiles;
selecting a predetermined time interval for reallocation of the wealth among the plurality of investment assets; and
determining, with the processing circuitry, the reallocation of the wealth among the plurality of investment assets at each predetermined time interval along the selected glide path profile based on the current age value of the user, the retirement age value of the user, the starting portfolio, the ending portfolio, the selected glide path, and the predetermined time interval for reallocation.

22. The method of claim 21, further comprising:
performing a Monte Carlo simulation.

23. The method of claim 20, where the at least one expected future return parameter for the portfolio is a representation of statistical probability of future success of the plurality of investment assets for the portfolio.

24. The method of claim 20, the method further comprising:
receiving a current age value of a user, and storing the current age value in the memory;
receiving a retirement age value of the user, and storing the retirement age value in the memory;
displaying, on the display screen, a plurality of questions for the user to determine a risk tolerance of the user;
receiving answers to the plurality of questions, and storing the answers in the memory;
determining, with the processing circuitry, the risk tolerance level for the user based on the answers to the plurality of questions;
determining, with the processing circuitry, constraints of allocating the wealth to the plurality of investment assets for the portfolio based on the current age value, the retirement age value, and the risk tolerance level; and
displaying the corresponding risk statistic and the corresponding expected future return parameter for each of the plurality of portfolios as a graph on the display screen,
wherein the corresponding expected future return parameter for each of the plurality of portfolios is a highest expected return for the corresponding risk statistic.

25. The method of claim 24, further comprising:
selecting a starting portfolio from the plurality of portfolios;
selecting an ending portfolio from the plurality of portfolios;
selecting a glide path profile from among a plurality of glide path profiles;
selecting a predetermined time interval for reallocation of the wealth among the plurality of investment assets; and
determining, with the processing circuitry, the reallocation of the wealth among the plurality of investment assets each predetermined time interval along the selected glide path profile based on the current age value of the user, the retirement age value of the user, the starting portfolio, the ending portfolio, the selected glide path, and the predetermined time interval for reallocation.

26. The method of claim 20, wherein the at least one risk statistic is a standard deviation of a risk of allocation of the wealth to the plurality of investment assets.

27. The method of claim 21, wherein the plurality of investment assets include only mutual funds and ETFs.

28. The method of claim 24, wherein the plurality of investment assets are divided into a plurality of classes, and wherein each of the plurality of classes is assigned to be within a minimum percentage value and a maximum percentage value of the total value of the wealth.

29. The method of claim 21, wherein the plurality of glide path profiles include a straight line glide path profile.

30. The method of claim 20, further comprising:
determining, with the processing circuitry, a corresponding best case return percentage and a corresponding worst case return percentage for each of the plurality of portfolios; and
displaying, on the display screen, said corresponding best case return percentage and said corresponding worst case return percentage for each of the plurality of portfolios.

31. The method of claim 25, further comprising:
displaying, on the display screen, the reallocation of the wealth among the plurality of investment assets at each predetermined time interval.

32. The method of claim 20, further comprising:
selecting a wealth goal and an inflation rate for one of the plurality of portfolios;
determining a value of the wealth goal at different periods of time based on the inflation rate;
determining, with the processing circuitry, a probability of achieving the value of the wealth goal at each of the different periods of time for the one of the plurality of portfolios; and
displaying, as a table on the display screen, the probability of achieving the value of the wealth goal at each of the different periods of time for the one of the plurality of portfolios.

33. The method of claim 20, further comprising:
selecting a benchmark to display a second expected future return parameter and a second risk statistic corresponding to the benchmark; and
displaying, on the display screen, the second expected future return parameter and the second risk statistic corresponding to the benchmark along with the first risk statistic and the first expected future return parameter for each investment asset from the corresponding plurality of investment assets for the at least one selected portfolio.

34. The method of claim 32, further comprising:
displaying, as a graph on the display screen, the probability of achieving the value of the wealth goal at each of the different periods of time for the one of the plurality of portfolios.
